(19) United States
(12) Patent Application Publication
(10) Pub. No.: US 2018/0162996 A1
(43) Pub. Date: Jun. 14, 2018

(54) POLYKETONE RESIN COMPOSITION WITH EXCELLENT WEAR RESISTANCE

(71) Applicant: HYOSUNG CORPORATION, Seoul (KR)

(72) Inventors: Jong In CHOI, Seoul (KR); Sung Kyoun YOON, Anyang-si (KR); Ka Young KIM, Anyang-si (KR); Seong Hwan KIM, Seoul (KR); Jong LEE, Seoul (KR)

(73) Assignee: HYOSUNG CORPORATION, Seoul (KR)

(21) Appl. No.: 15/524,422

(22) PCT Filed: Oct. 19, 2015
(86) PCT No.: PCT/KR2015/011026

§ 371 Date: May 4, 2017

(30) Foreign Application Priority Data
Nov. 7, 2014 (KR) 10-2014-0154631
Nov. 7, 2014 (KR) 10-2014-0154632
Nov. 19, 2014 (KR) 10-2014-0161980
Nov. 19, 2014 (KR) 10-2014-0161984
Nov. 19, 2014 (KR) 10-2014-0161985
Nov. 19, 2014 (KR) 10-2014-0162002
Nov. 19, 2014 (KR) 10-2014-0162020
Nov. 19, 2014 (KR) 10-2014-0162021
Nov. 19, 2014 (KR) 10-2014-0162023
Nov. 19, 2014 (KR) 10-2014-0162024
May 27, 2015 (KR) 10-2015-0073986
May 27, 2015 (KR) 10-2015-0073987
May 27, 2015 (KR) 10-2015-0073988
May 27, 2015 (KR) 10-2015-0073990
May 27, 2015 (KR) 10-2015-0073991
May 27, 2015 (KR) 10-2015-0073992
May 27, 2015 (KR) 10-2015-0074015
May 27, 2015 (KR) 10-2015-0074018
May 27, 2015 (KR) 10-2015-0074019
May 27, 2015 (KR) 10-2015-0074021
May 27, 2015 (KR) 10-2015-0074022
May 27, 2015 (KR) 10-2015-0074025
May 27, 2015 (KR) 10-2015-0074026
May 27, 2015 (KR) 10-2015-0074027
May 27, 2015 (KR) 10-2015-0074030
May 27, 2015 (KR) 10-2015-0074031
May 27, 2015 (KR) 10-2015-0074034
May 27, 2015 (KR) 10-2015-0074036

(51) Int. Cl. C08G 67/02; F24C 15/08; E05B 85/20; C08L 83/04; C08J 5/00; A47L 7/00; B60J 5/00; B60J 3/00; B29C 45/00; C08F 4/32

(52) U.S. Cl. CPC C08G 67/02; F24C 15/08; E05B 85/20; C08L 83/04; C08F 4/32; A47L 7/00; B60J 5/00; B60J 3/00; B29C 45/00; C08J 5/00

(57) ABSTRACT

The present invention relates to a polyketone resin composition which is prepared from a polyketone co-polymer comprising repeating units represented by general formulae (1) and (2) below and exhibits excellent wear resistance and impact resistance, and thus can be used for gears, microwave containers, cams, helmet gears for electric welding, plastic boards, yarn guides, bedding cleaner cams, office supplies, window drums for automobiles, sun visor retainers, door frame inner covers for automobiles, safety belt jointers for automobiles, auto gear slides for automobiles, door latch housings for automobiles, slide guides for automobiles, switch shafts in heating, ventilation and air conditioning (HAVC) systems for automobiles, actuator gears for automobiles, trim mounting clips for automobiles, cup holders for automobiles, roof racks for automobiles, outside door handles for automobiles, air intake garnishes for automobiles, medical transportation trays, medical pipettes, refrigerator door closures, cellular phone polishing fixtures, ATM gears, etc.

—[—CH₂CH₂—CO]x- (1)

—[—CH₂—CH(CH₃)—CO]y- (2)

(wherein x and y denote the mol % of each of the general formula (1) and (2) in a polymer, and y/x is from 0.03 to 0.3)

### TECHNICAL FIELD

The present invention relates to a polyketone resin composition with excellent wear resistance and impact resistance, and more particularly, to a polyketone resin composition which is produced by mixing a wear resistant agent with a polyketone copolymer and can be used for gears, microwave containers, cams, helmet gears for electric welding, plastic boards, yarn guides, bedding cleaner cams, office supplies, window drums for automobiles, sun visor retainers, door frame inner covers for automobiles, safety belt jointers for automobiles, auto gear slides for automobiles, door latch housings for automobiles, slide guides for automobiles, switch shafts in heating, ventilation and air conditioning (HAVC) systems for automobiles, actuator gears for automobiles, trim mounting clips for automobiles, cup holders for automobiles, roof racks for automobiles, outside door handles for automobiles, air intake garnishes for automobiles, medical transportation trays, medical pipettes, refrigerator door closures, cellular phone polishing fixtures, ATM gears, etc.

### BACKGROUND ART

Engineering plastics such as polyacetal, polyamide, polyester, polycarbonate and etc. are conventionally used in various industrial fields such as gears, microwave containers, cams, helmet gears for electric welding, plastic boards, yarn guides, bedding cleaner cams, office supplies, window drums for automobiles, sun visor retainers, door frame inner covers for automobiles, safety belt jointers for automobiles, auto gear slides for automobiles, door latch housings for automobiles, slide guides for automobiles, switch shafts in heating, ventilation and air conditioning (HAVC) systems for automobiles, actuator gears for automobiles, trim mounting clips for automobiles, cup holders for automobiles, roof racks for automobiles, outside door handles for automobiles, air intake garnishes for automobiles, medical transportation trays, medical pipettes, refrigerator door closures, cellular phone polishing fixtures and etc. The engineering plastics are excellent in mechanical properties, fatigue resistance, oil resistance, and electrical properties, but they are unsatisfactory in wear resistance due to load or external force and impact resistance to withstand external impacts.

Recently, research is underway to replace the engineering plastic with polyketone (PK). The polyketone is obtained by polymerizing carbon monoxide (CO) and olefin such as ethylene and propylene using a transition metal complex such as palladium (Pd) or nickel (Ni) as a catalyst, thereby alternately bonding carbon monoxide and olefin. The polyketone thus produced is not only low in raw material and polymerization process cost as compared with conventional engineering plastics such as polyacetal, polyamide, polyester and polycarbonate but also superior in terms of wear resistance and impact resistance. In addition, it has a same level of strength as conventional engineering plastics.

Looking at techniques for improving the wear resistance of conventional engineering plastics, Korean Registered Patent Application No. 10-1086028 discloses a method of improving a wear resistance of plastics by uniformly mixing particulate carbon black with any one molten plastic material selected from a group comprising polyethylene (PE), polyacetal (POM), polyurethane, and nylon at a weight ratio of 90 to 110:5 to 35. In case of polyketone, U.S. Pat. No. 4,870,133 discloses a technique for blending polytetrafluoroethylene with polyketone to improve melt strength.

However, research to improve the wear resistance of polyketone has not yet been conducted or reported.

### DISCLOSURE

### Technical Problem

The present invention provides a polyketone resin composition with excellent wear resistance and impact resistance and a method for producing the same.

The polyketone resin composition of the present invention can be used as gears, microwave containers, cams, helmet gears for electric welding, plastic boards, yarn guides, bedding cleaner cams, office supplies, window drums for automobiles, sun visor retainers, door frame inner covers for automobiles, safety belt jointers for automobiles, auto gear slides for automobiles, door latch housings for automobiles, slide guides for automobiles, switch shafts in heating, ventilation and air conditioning (HAVC) systems for automobiles, actuator gears for automobiles, trim mounting clips for automobiles, cup holders for automobiles, roof racks for automobiles, outside door handles for automobiles, air intake garnishes for automobiles, medical transportation trays, medical pipettes, refrigerator door closures, cellular phone polishing fixtures, ATM gears and etc.

### Technical Solution

The present invention is directed to providing a vehicle fuel tank manufactured by injection-molding a blend of 100 parts by weight of a polyketone copolymer comprising repeating units represented by following general formula (1) and (2) and having y/x of 0.03 to 0.3, and 0.1 to 20 parts by weight of at least one or more kinds of wear resistant agent selected from a group comprising silicon, polytetrafluoroethylene, calcium carbonate, maleic acid, molybdenum, glass fiber and magnesium stearate.

—(CH₂CH₂—CO)x- (1)

—(CH₂CH(CH₃)—CO)y- (2)

(x and y are mole % of each of the general formula (1) and (2) in a polymer)

Also, the present invention provides gears, microwave containers, cams, helmet gears for electric welding, plastic boards, yarn guides, bedding cleaner cams, office supplies, window drums for automobiles, sun visor retainers, door frame inner covers for automobiles, safety belt jointers for automobiles, auto gear slides for automobiles, door latch housings for automobiles, slide guides for automobiles, switch shafts in heating, ventilation and air conditioning (HAVC) systems for automobiles, actuator gears for automobiles, trim mounting clips for automobiles, cup holders for automobiles, roof racks for automobiles, outside door handles for automobiles, air intake garnishes for automobiles, medical transportation trays, medical pipettes, refrigerator door closures, cellular phone polishing fixtures manufactured by injection-molding a polyketone copolymer comprising repeating units represented by following general formula (1) and (2) and having y/x of 0.03 to 0.3.

—(CH₂CH₂—CO)x- (1)

—(CH₂CH(CH₃)—CO)y- (2)

(x and y are mole % of each of the general formula (1) and (2) in a polymer)

The present invention provides polyketone molded components manufactured by injection molding polyketone composition manufactured by blending a linear alternating polyketone comprising carbon monoxide and at least one kind of olefinically unsaturated hydrocarbon; and at least one or more kinds of wear resistant agent selected from a group comprising silicon, polytetrafluoroethylene, calcium carbonate, maleic acid, molybdenum, glass fiber and magnesium stearate, and having wear amount of 0.005 g or less measured at speed of 50 rpm, a load of 150N and wear distance of 3 km, wherein the linear alternating polyketone preferably has a molar ratio of ethylene to propylene of 9 to 24:1, a polyketone content of 80 to 99.9 weight % based on total weight of the polyketone composition and a content of wear resistant agent of 0.1 to 20 weight %, intrinsic viscosity of 1.0 to 2.0 dl/g and a molecular weight distribution of 1.5 to 2.5, and the polyketone molded components are one selected from a group comprising a wear part in OA, an ATM gear, an electric/electronic gear, a city gas meter gear and razor printer toner gear.

The present invention provides microwave containers manufactured by injection molding a linear alternating polyketone polymer comprising carbon monoxide and at least one kind of olefinically unsaturated hydrocarbon and having a residual amount of palladium catalyst of 50 ppm or less and a molecular weight distribution of 1.5 to 2.5, wherein the linear alternating polyketone polymer has a molar ratio of ethylene to propylene of 9 to 24:1, intrinsic viscosity of 1.0 to 2.0 dl/g and wear amount of 1.0 mm3/kg/km or less in base state.

The present invention provides polyketone cams manufactured with polyketone copolymer comprising repeating units represented by general formula (1) and (2) described above, wherein the polyketone copolymer has intrinsic viscosity of 1.0 to 2.0 dl/g, a noise level during wear measurement of 70 dB or less and wear amount measured using a Taber wear tester (manufactured by DAITO ELECTRON CO., LTD., condition: 1 kg of load and wear wheel H-22) according to JIS K-7311 after a test piece was left at 25° C. for 2 days of 25 mg or less.

The present invention provides gears attached to an electric welding helmet manufactured with a polyketone resin comprising repeating units represented by general formula (1) and (2) described above, wherein the polyketone resin has intrinsic viscosity of 1.0 to 2.0 dl/g, a molecular weight distribution of 1.5 to 2.5, and the gear has a wear coefficient (K_{LNP}) of 200 to 300 measured at 25° C. using a thrust washer test device.

The present invention provides polyketone plastic boards for blanking and molding a plastic gear which is a polyketone copolymer comprising repeating units represented by general formula (1) and (2) described above and has wear amount of 0.020 g or less in speed of 50 rpm, a load of 150 N and wear distance of 3 km under JIS K7218 standard, wherein wear resistant agent is added and it is a silicone resin in powder form and contains 0.1 to 15 parts by weight relative to 100 parts by weight of the polyketone copolymer, and the polyketone copolymer has intrinsic viscosity of 1.0 to 2.0 dl/g and a molecular weight distribution of 1.5 to 2.5.

The present invention provides yarn guides, which guide a yarn wound on a bobbin to a needle, comprising; a yarn guide hole through which a yarn passes; a yarn path for guiding the yarn passing through the yarn guide hole to the needles; a guide member and a roller, and manufactured with a polyketone copolymer comprising repeating units represented by general formula (1) and (2) described above, wherein intrinsic viscosity of the polyketone copolymer is 1.0 to 2.0 dl/g, a ligand of a catalyst composition used in polymerization of the polyketone copolymer is ((2,2-dimethyl-1,3-dioxane-5,5-diyl)bis(methylene))bis(bis(2-methoxyphenyl)phosphine) and a molecular weight distribution of the polyketone copolymer is 1.5 to 2.5.

The present invention provides polyketone microwave components manufactured by injection molding a linear alternating polyketone which is polyketone copolymer comprising repeating units represented by general formula (1) and (2) described above, and has y/x of 0.03 to 0.3, wherein intrinsic viscosity of the polyketone is 1.0 to 2.0 dl/g, wear amount of the microwave components manufactured by injection molding is 1.0 mm3/kg/km or less, the microwave components are turntable rollers or turntable brackets, a thermal strain temperature of the microwave components is 130° C. or higher and the microwave components have an injection cycle of less than 20 sec.

The present invention provides cams for bedding cleaner, which is fixed to a rotating shaft of a vibrator for vibrating a suction mechanism of a bedding cleaner and linearly reciprocates connecting road, manufactured with polyketone copolymer comprising repeating units represented by general formula (1) and (2) described above, wherein the polyketone copolymer is prepared by a step of preparing a catalyst composition comprising a palladium compound, an acid having a pKa value of 6 or less, and a bidentate compound of phosphorus; a step of preparing a mixed solvent comprising methanol and water; a step of conducting polymerization in presence of the catalyst composition and the mixed solvent to prepare a linear terpolymer of carbon monoxide, ethylene and propene; a step of obtaining polyketone resin removing a remaining catalyst composition in the prepared linear terpolymer with an alcohol solvent, intrinsic viscosity of the polyketone copolymer measured at 25° C. by HFIP (hexa-fluoroisopropano) is 1.0 to 2.0 dl/g and wear amount of cams is 25 mg or less.

The present invention provides office supplies manufactured by injection molding a linear alternating polyketone comprising carbon monoxide and at least one kind of olefinically unsaturated hydrocarbon and having a molecular weight distribution of 1.5 to 2.5 and a residual amount of palladium catalyst of 20 ppm or less, wherein impact strength is 8 to 15 kJ/m2, a ligand of a catalyst composition in polymerization of the linear alternating polyketone is ((2,2-dimethyl-1,3-dioxane-5,5-diyl)bis(methylene))bis(bis(2-methoxyphenyl)phosphine), it is manufactured by injection molding a polyketone composition produced by blending a wear resistant agent and the linear alternating polyketone having wear resistance of 1.0 mm3/kg/km or less in a base state and intrinsic viscosity of 1.0 to 2.0 dl/g and comprising carbon monoxide and at least one kind of olefinic unsaturation hydrocarbon and also having a molecular weight distribution of 1.5 to 2.5 and a residual amount of a palladium catalyst of 20 ppm or less. In this case, wear amount is 0.1 mm3/kg/km or less and content of wear resistant agent is 0.5 to 2.0 weight % based on total polyketone composition, and the wear resistant agent is a silicone oil or silicone gum.

The present invention provides window drums for automobiles manufactured by injection molding a polyketone composition comprising a linear alternating polyketone polymer comprising carbon monoxide and at least one kind of olefinically unsaturated hydrocarbon and having a residual amount of a palladium catalyst of 5 to 50 ppm and a molecular weight distribution of 1.5 to 3.0, wherein the polyketone composition further comprises a silicon-based wear resistant agent, content of the silicon-based wear resistant agent is 2 to 20 weight % based on 100 weight % of the entire polyketone composition, a molar ratio of ethylene to propylene is 99:1 to 85:15, intrinsic viscosity of the linear alternating polyketone polymer is 1.2 to 2.0 dl/g, and the window drums for automobiles has impact strength of 10 kJ/m2 or more and wear resistance in the base state of 0.015 g or less.

The present invention provides sun visor retainers manufactured by injection molding a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein a molar ratio of ethylene to propylene is 99:1 to 85:15, intrinsic viscosity is 1.2 to 2.0 dl/g, and the sun visor retainers for automobiles have wear resistance Rmax of 1.0 or less.

The present invention provides door frame inner covers for automobiles manufactured by injection molding a blend comprising 60 to 85 weight % of a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, and 15 to 40 weight % of glass fiber, wherein a molar ratio of ethylene to propylene is 99:1 to 85:15, intrinsic viscosity is 1.2 to 2.0 dl/g, and the door frame inner covers for automobiles have impact strength of 20 kJ/m2 or more and a dimensional change rate of 2% or less.

The present invention provides safety belt jointers for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein the polyketone composition further comprises at least one kind selected from a group comprising a silicon-based wear resistant agent, a glass fiber and a polytetrafluoroethylene resin, a molar ratio of ethylene to propylene is 99:1 to 85:15, intrinsic viscosity of the linear alternating polyketone polymer is 1.2 to 2.0 dl/g, and the safety belt jointers for automobiles have impact strength of 10 kJ/m2 or more and wear amount is 0.015 g or less in a base state.

The present invention provides auto gear slides for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein the polyketone composition further comprises at least one kind selected from a group comprising a silicon-based wear resistant agent, a glass fiber and a polytetrafluoroethylene resin, a molar ratio of ethylene to propylene is 99:1 to 85:15, intrinsic viscosity is 1.2 to 2.0 dl/g, and the auto gear slides for automobiles have wear amount of 0.015 g or less in a base state.

The present invention provides door latch housing for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein the polyketone composition further comprises a silicon-based wear resistant agent, content of the silicon-based wear resistant agent is 2 to 20 weight % based on 100 weight % of the entire polyketone composition, a molar ratio of ethylene to propylene is 99:1 to 85:15, intrinsic viscosity of the linear alternating polyketone polymer is 1.2 to 2.0 dl/g, and the door latch housing for automobiles has impact strength of 10 kJ/m2 or more and wear resistance in the base state of 0.015 g or less.

The present invention provides slide guides for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein the polyketone composition further comprises a silicon-based wear resistant agent, content of the silicon-based wear resistant agent is 2 to 20 weight % based on 100 weight % of the entire polyketone composition, a molar ratio of ethylene to propylene is 99:1 to 85:15, intrinsic viscosity of the linear alternating polyketone polymer is 1.2 to 2.0 dl/g, and the slide guides for automobiles has impact strength of 10 kJ/m2 or more and wear resistance in the base state of 0.015 g or less.

The present invention provides switch shafts in heating, ventilation and air conditioning (HAVC) systems for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein the polyketone composition further comprises at least one kind selected from a group comprising a silicon-based wear resistant agent, a glass fiber and a polytetrafluoroethylene resin, a molar ratio of ethylene to propylene is 99:1 to 85:15, intrinsic viscosity of the linear alternating polyketone polymer is 1.2 to 2.0 dl/g, impact strength of 10 kJ/m2 or more, and wear amount is 0.015 g or less in a base state.

The present invention provides actuator gears for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein at least one kind selected from a group comprising a silicon-based wear resistant agent, a glass fiber and a polytetrafluoroethylene resin is further included, a molar ratio of ethylene to propylene is 99:1 to 85:15, intrinsic viscosity of the linear alternating polyketone polymer is 1.2 to 2.0 dl/g, and the actuator gear for automobiles have impact strength of 10 kJ/m2 or more and wear amount is 0.015 g or less in a base state.

The present invention provides trim mounting clips for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein the polyketone composition further comprises at least one kind selected from a group comprising a silicon-based wear resistant agent, a glass fiber and a polytetrafluoroethylene resin, a molar ratio of ethylene to propylene is 99:1 to 85:15, intrinsic viscosity of the linear alternating polyketone polymer is 1.2 to 2.0 dl/g, and the trim mounting clip for automobiles have impact strength of 10 kJ/m2 or more and wear amount of 0.015 g or less in a base state.

The present invention provides cup holders for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, wherein the polyketone composition further comprises at least one kind selected from a group comprising a silicon-based wear resistant agent, a glass fiber and a polytetrafluoroethylene resin, a molar ratio of ethylene to propylene is 99:1 to 85:15, intrinsic viscosity of the linear alternating polyketone polymer is 1.2 to 2.0 dl/g, and the cup holder for automobiles have impact strength of 10 kJ/m2 or more and wear amount of 0.015 g or less in a base state.

The present invention provides roof racks for automobiles manufactured by injection molding a blend comprising 60 to 90 weight % of a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, and 10 to 40 weight % of glass fiber, wherein a molar ratio of ethylene to propylene is 99:1 to 85:15, intrinsic viscosity of the linear alternating polyketone polymer is 1.2 to 2.0 dl/g, and the roof racks for automobiles have impact strength of 10 kJ/m2 and pencil hardness of 3H or more.

The present invention provides outside door handle for automobiles manufactured by injection molding a blend comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, a glass fiber and a mineral filler, wherein content of the glass fiber is 5 to 30 weight % based on total blend and content of the mineral filler is 10 to 20 weight %. In this case, the linear alternating polyketone polymer has a molar ratio of ethylene to propylene of 99:1 to 85:15 and intrinsic viscosity of 1.2 to 2.0 dl/g, the mineral filler is one selected from a group comprising talc, kaolin, mica, wollastonite, TiO2-coated mica platelets, silica, alumina, borosilicates and oxides, and the outside door handle for automobiles have impact strength of 10 kJ/m2 or more and dimensional change rate of 1.5% or less.

The present invention provides air intake garnish for automobiles manufactured by injection molding a blend comprising 60 to 85 weight % of a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, and 15 to 40 weight % of glass fiber, wherein a molar ratio of ethylene to propylene is 99:1 to 85:15, intrinsic viscosity of the linear alternating polyketone polymer is 1.2 to 2.0 dl/g, and the air intake garnish for automobiles have impact strength of 20 kJ/m2 or more and wear resistance Rmax of 1.0 or less.

The present invention provides medical transportation tray manufactured by injection molding a polyketone composition comprising a linear alternating polyketone which is polyketone copolymer comprising repeating units represented by general formula (1) and (2) described above, and has y/x of 0.1 to 0.3, wherein the polyketone composition further comprises at least one kind selected from a group comprising a silicon-based wear resistant agent, a glass fiber and a polytetrafluoroethylene resin, the medical transportation tray has wear amount of 0.015 g or less at a base state, the polyketone has intrinsic viscosity of 1.0 to 2.0 dl/g, and a ligand of a catalyst composition used in polyketone polymerization is ((2,2-dimethyl-1,3-dioxane-5,5-diyl)bis(methylene))bis(bis(2-methoxyphenyl)phosphine).

The present invention provides medical pipette manufactured by injection molding a polyketone composition comprising a linear alternating polyketone which is polyketone copolymer comprising repeating units represented by general formula (1) and (2) described above, and has y/x of 0.1 to 0.3, wherein the polyketone composition further comprises at least one kind selected from a group comprising a silicon-based wear resistant agent, a glass fiber and a polytetrafluoroethylene resin, the medical pipette has flexural strength of 180 MPa or more and wear amount of 0.015 g or less at a base state, the polyketone has intrinsic viscosity of 1.0 to 2.0 dl/g, and a ligand of a catalyst composition used in polyketone polymerization is ((2,2-dimethyl-1,3-dioxane-5,5-diyl)bis(methylene))bis(bis(2-methoxyphenyl)phosphine).

The present invention provides refrigerator door closure manufactured by injection molding a polyketone composition comprising a linear alternating polyketone which is polyketone copolymer comprising repeating units represented by general formula (1) and (2) described above, and has y/x of 0.1 to 0.3, wherein the polyketone composition further comprises a polytetrafluoroethylene resin and thermoplastic polyurethane rein, the refrigerator door closure has wear amount of 0.015 g or less at a base state, the polyketone has intrinsic viscosity of 1.0 to 2.0 dl/g, and a ligand of a catalyst composition used in polyketone polymerization is ((2,2-dimethyl-1,3-dioxane-5,5-diyl)bis(methylene))bis(bis(2-methoxyphenyl)phosphine).

The present invention provides cellular phone polishing fixture manufactured by injection molding a polyketone composition comprising a linear alternating polyketone which is polyketone copolymer comprising repeating units represented by general formula (1) and (2) described above, and has y/x of 0.1 to 0.3, wherein the polyketone composition further comprises a polytetrafluoroethylene resin, the cellular phone polishing fixture has tensile strength of 30 MPa or more, the polyketone has intrinsic viscosity of 1.0 to 2.0 dl/g, and a ligand of a catalyst composition used in polyketone polymerization is ((2,2-dimethyl-1,3-dioxane-5,5-diyl)bis(methylene))bis(bis(2-methoxyphenyl)phosphine).

Also, the present invention provides a polyketone resin composition for ATM gears, which is comprising 100 parts by weight of polyketone resin which is polyketone copolymer comprising repeating units represented by following general formula (1) and (2), and has y/x of 0.1 to 0.3 and 0.1 to 15 parts by weight of silicone resin relative to 100 parts by weight of the polyketone resin.

—(CH₂CH₂—CO)x- (1)

—(CH₂CH(CH₃)—CO)y- (2)

(x and y are mole % of each of the general formula (1) and (2) in a polymer)

In this case, the silicone resin is in a form of powder and preferably has a diameter of 1 to 2 μm.

Also, the polyketone resin preferably has intrinsic viscosity of 1.0 to 2.0 dl/g.

Also, the polyketone resin preferably has a molecular weight distribution of 1.5 to 2.5.

Also, wear amount of the polyketone resin composition is 0.020 g or less in a speed of 50 rpm, a load of 150 N and a wear distance of 3 km under JIS K7218 standard.

### Advantageous Effects

A polyketone resin composition manufactured by a method of the present invention has excellent wear resistance and impact resistance, thereby there is an effect of exhibiting properties suitable for use in gears, microwave containers, cams, helmet gears for electric welding, plastic boards, yarn guides, bedding cleaner cams, office supplies, window drums for automobiles, sun visor retainers, door frame inner covers for automobiles, safety belt jointers for automobiles, auto gear slides for automobiles, door latch housings for automobiles, slide guides for automobiles, switch shafts in heating, ventilation and air conditioning (HAVC) systems for automobiles, actuator gears for automobiles, trim mounting clips for automobiles, cup holders for automobiles, roof racks for automobiles, outside door handles for automobiles, air intake garnishes for automobiles, medical transportation trays, medical pipettes, refrigerator door closures, cellular phone polishing fixtures, ATM gears and etc.

### BRIEF DESCRIPTION OF THE DRAWINGS

FIG. 1 is a schematic view of a thrust washer test device for evaluating wear resistance.

FIG. 2 shows a process for producing a plastic gear by blanking a plastic board of the present invention.

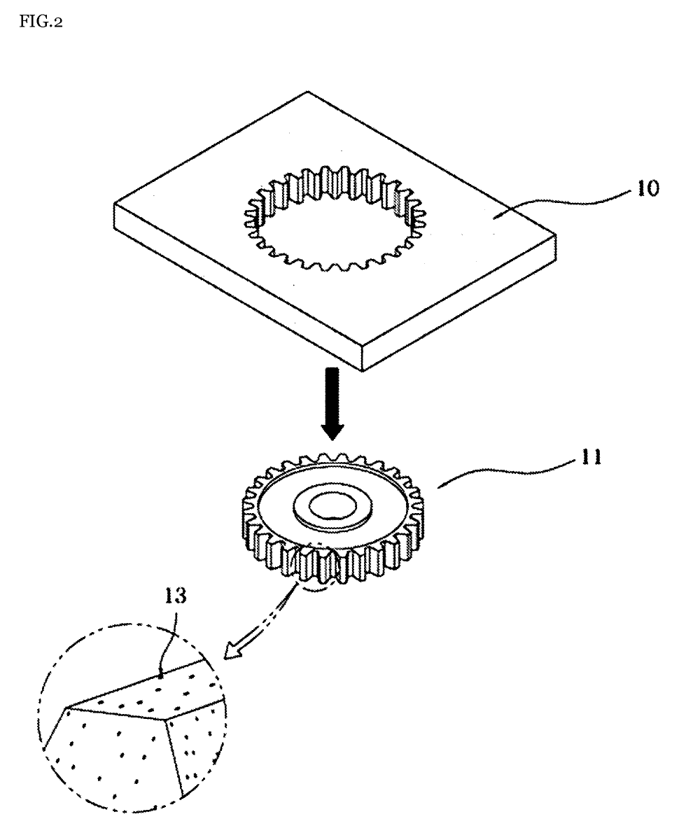

### DETAILED DESCRIPTION OF THE PREFERRED EMBODIMENTS

Hereinafter, the present invention is described in more detail based on embodiments. The present invention may be modified in various different ways and may have various embodiments.

A polyketone of the present invention is a linear alternating structure and substantially contains carbon monoxide per one molecule of unsaturated hydrocarbon. Ethylenically unsaturated hydrocarbon suitable for use as precursor of the polyketone has up to 20, preferably up to 10 carbon atoms. Also, ethylenically unsaturated hydrocarbons is ethene, α-olefin, aliphatic such as propene, 1-butene, iso-butene, 1-hexene and 1-octene or an aryl aliphatic containing an aryl substituent on another aliphatic molecule, particularly containing an aryl substituent on an ethylenically unsaturated carbon atom. Examples of aryl aliphatic hydrocarbons in ethylenically unsaturated hydrocarbons include styrene, p-methyl styrene, p-ethyl styrene and m-isopropyl styrene. A polyketone polymer preferably used in the present invention is a copolymer of carbon monoxide and ethene or a second ethylenically unsaturated hydrocarbon having carbon monoxide, ethene and at least three carbon atoms, in particular terpolymer with α-olefins such as propene.

When the polyketone terpolymer is used as a main polymer component of the blend of the present invention, there are at least two units comprising an ethylene part in each unit comprising a second hydrocarbon part in the terpolymer. There is preferably 10 to 100 of units comprising the second hydrocarbon part.

A preferred polymer ring of the polyketone polymer in the present invention is represented by following general formula (1).

COCH₂—CH₂ₓCOC_{y} [Formula 1]

In the above formula (1), G is an ethylenically unsaturated hydrocarbon, particularly a part obtained from an ethylenically unsaturated hydrocarbon having at least three carbon atoms, and x:y is at least 2:1.

In the above, when y is 0, it can be represented by following general formula (2), and it becomes a copolymer and does not contain a second ethylenic unsaturated hydrocarbon.

—CO—CH₂CH₂

and; —COG. [Formula 2]

Units of formula (2) are randomly applied throughout polymer chain. A preferred y:x ratio is 0.01 to 0.5. A terminal root, or “cap”, of a polymeric ring is determined by what material is present during preparation of the polymer, and whether the polymer is to be purified or how the polymer is to be purified.

Number average molecular weight measured by gel penetration chromatography is preferably 100 to 200,000 and especially polyketone of 20,000 to 90,000 is preferable. Physical properties of polymer are set according to molecular amount, according to whether polymer is copolymer or terpolymer, and in case of terpolymer according to character of the second hydrocarbon. Ordinary melting point of polymer used in the present invention is 175° C. to 300° C., and generally 210° C. to 270° C. Limiting Viscosity Number (LVN) of polymer measured by standard viscosity measuring device and HFIP (Hexafluoroisopropylalcohol) in 60° C. is 0.5 dl/g to 10 dl/g, and preferably 1.0 dl/g to 2.0 dl/g. In this case, if Limiting Viscosity Number is less than 0.5 dl/g, mechanical properties are declined, and if it is more than 10 dl/g, processability is declined.

Polyketone manufacturing method can use liquefied polymerization implemented under alcohol solvent through catalyst composition comprising carbon monoxide, olefin palladium compound, acid of 6 or less pKa, and bidentate ligand compound of phosphorus. Polymerization reaction temperature is preferably 50 to 100° C. and reaction pressure is 40 to 60 bar. After polymerization of polymer, through purified process retrieving and remained catalyst composition is removed by solvent such as alcohol or acetone.

In this case, for palladium compound, acetic acid palladium is preferable and the amount is preferably 10-3 to 10-1 1 mole. Examples of acid with less than 6 pKa are trifluoroacetic acid, p-toluenesulfonic acid, sulfuric acid, sulfonic acid, and etc. In the present invention, trifluoroacetic acid is used and the amount is compared to palladium 6 to 20 equivalent weight. Also, bidentate ligand compound of phosphorus is preferably ((2,2-dimethyl-1,3-dioxane-5,5-diyl)bis(methylene))bis(bis(2-methoxyphenyl)phosphine), and the amount is compared to palladium 1 to 1.2 equivalent weight.

The following statement explains polymerization of polyketone in detail.

Carbon monoxide, ethylenically unsaturated compound, and one or more ollefinically unsaturated compound, three or more copolymer, especially monoxide-oriented repeating unit, and ethylenically unsaturated compound-oriented repeating unit, and propylenically unsaturated compound-oriented repeating unit are alternatively connected in structure of polyketone, the polyketone is excellent in mechanical properties and thermal properties and processibility, and having high abrasion resistance, chemical resistance, and gas barrier ability, therefore, useful in a variety of applications. High molecular weight of copolymer, terpolymer, or more copolymerized polyketone has higher processability and thermal properties, and regarded as useful engineering plastic with excellent economic efficiency. Especially, having high wear resistance used as component such as automobile gear, having high chemical resistance used as lining material of chemical transport pipe, and having high gas barrier ability used as light weight gasoline tank. In addition, in case of using ultra high molecular weight polyketone having 2 or more intrinsic viscosity in fiber, elongation of high magnification is possible, fiber having high strength and high elasticity modulus oriented in elongation direction, and it is suitable material in construction material and industrial material such as reinforcement of belt and rubber hose, and reinforcement of tire cord and concrete.

Polyketone manufacturing method under the presence of (a) Group 9, Group 10 or Group 11 transition metal compound, (b) organic metal complex catalyst comprising ligand having Group 15 element in polyketone manufacturing method by terpolymerization of carbon monoxide, ethylenically and propylenically unsaturated compound among liquid medium, the carbon monoxide, ethylene, and propylene liquefied polymerized in mixed solvent of alcohol (for example, methanol) and water, and produces linear terpolymer, and for the mixed solvent, mixture of methanol 100 part by weight and water 2 to 10 part by weight can be used. In mixed solvent if content of water is less than 2 part by weight, ketal is formed and thermal stability can be declined in process, and if content of water is more than 10 part by weight, mechanical properties of product can be declined.

A mixed solvent comprising 7090 volume % of acetic acid and 1030 volume % of water is used as a liquid medium, and benzophenone is added during polymerization.

In this case, for liquid medium, methanol, dichloromethane or nitromethane which were mainly used in conventional polyketone manufacturing are not used, and mixed solvent comprising acetic acid and water is used. By using mixed solvent of acetic acid and water for liquid medium in polyketone manufacture, manufacturing cost of polyketone is reduced and catalytic activity is enhanced. In addition, since a use of methanol or dichloromethane solvent forms a mechanism to induce a stopping reaction in polymerization step, a use of acetic acid or water other than methanol or dichloromethane in the solvent does not have an effect of stopping a catalytic activity stochastically, it plays a big role in improving a polymerization activity.

In case of using mixed solvent of acetic acid and water for liquid medium, if concentration of water is less than 10 vol %, it impacts less in catalyst activity, and if concentration is more than 10 vol %, catalyst activity is rapidly increased. Meanwhile, if concentration of water is more than 30 vol %, catalyst activity tends to decrease. Therefore, for liquid medium, mixed solvent comprising acetic acid of 7090 vol % and water of 1030 vol % is preferably used.

In this case, catalyst comprises periodic table (IUPAC Inorganic Chemistry Nomenclature revised edition, 1989) (a) Group 9, Group 10 or Group 11 transition metal compound, (b) ligand having Group 15 element.

Among Group 9, Group 10 or Group 11 transition metal compound (a), examples of Group 9 transition metal compound are cobalt or ruthenium complex, carbon acid salt, phosphate, carbamate, sulfonate, and etc., specific examples are cobalt acetate, cobalt acetylacetate, ruthenium acetate, trifluoro-ruthenium acetate, ruthenium acetylacetate, trifluoro-methane sulfonic acid, and etc.

Examples of Group 10 transition metal compound are nickel or palladium complex, carbon acid salt, phosphate, carbamate, sulfonate, and etc., specific examples are nickel acetate, nickel acetylacetate, palladium acetate, trifluoro-palladium acetate, palladium acetylacetate, palladium chloride, bis(N,N-diethyl carbamate)bis(diethylamine)palladium, palladium sulfate, and etc.

Examples of Group 11 transition metal compound are copper or silver complex, carbon acid salt, phosphate, carbamate, sulfonate, and etc., specific examples are copper acetate, trifluoro-copper acetate, copper acetylacetate, silver acetate, trifluoro-silver acetate, silver acetylacetate, trifluoro-methane sulfonic silver, and etc.

Among them transition metal compound (a) preferable in cost and economically are nickel and copper compound, transition metal compound (a) preferable in the yield and molecular weight of polyketone is palladium compound, and in terms of enhancing catalyst activity and intrinsic viscosity using palladium acetate is most preferable.

Examples of ligand having Group 15 atom (b) are nitrogen ligand such as 2,2′-bipyridyl, 4,4′-dimethyl-2,2′-bipyridyl, 2,2′-bi-4-picoline, 2,2′-bikinoline and etc., and phosphorus ligand such as 1,2-bis(diphenylphosphino)ethane, 1,3-bis(diphenylphosphino)propane, 1,4-bis(diphenylphosphino)butane, 1,3-bis[di(2-methyl)phosphino]propane, 1,3-bis[di(2-isopropyl)phosphino]propane, 1,3-bis[di(2-methoxyphenyl)phosphino]propane, 1,3-bis[di-methoxy-4-sodium sulfonate-phenyl)phosphino]propane, 1,2-bis(diphenylphosphino)cyclohexane, 1,2-bis(diphenylphosphino)benzene, 1,2-bis[[diphenylphosphino]methyl]benzene, 1,2-bis[[di(2-methoxyphenyl)phosphino]methyl]benzene, 1,2-bis[[di(2-methoxy-4-sodium sulfonate-phenyl)phosphino]methyl]benzene, 1,1′-bis(diphenylphosphino)ferrocene, 2-hydroxy-1,3-bis[di(2-methoxyphenyl)phosphino]propane, 2,2-dimethyl-1,3-bis[di(2-methoxyphenyl)phosphino]propane, and etc.

Among them preferable ligand having Group 15 element (b) is phosphorous ligand having Group 15 element, especially in terms of the yield of polyketone preferable phosphorous ligand is 1,3-bis[di(2-methoxyphenyl)phosphino]propane, 1,2-bis[[di(2-methoxyphenyl)phosphino]methyl]benzene, in terms of molecular weight of polyketone preferably 2-hydroxy-1,3-bis[di(2-methoxyphenyl)phosphino]propane, in terms of safety and not needing organic solvent preferably water soluble 1,3-bis[di(2-methoxy-4-sodium sulfonate-phenyl)phosphino]propane, 1,2-bis[[di(2-methoxy-4-sodium sulfonate-phenyl)phosphino]methyl]benzene, in terms of economic aspect and synthesis is easy preferably 1,3-bis(diphenylphosphino)propane, 1,4-bis(diphenylphosphino)butane. Preferable ligand having Group 15 element (b) is 1,3-bis[di(2-methoxyphenyl)phosphino]propane or 1,3-bis(diphenylphosphino)propane, and most preferably 1,3-bis[di(2-methoxyphenyl)phosphino]propane or ((2,2-dimethyl-1,3-dioxane-5,5-diyl)bis(methylene))bis(bis(2-methoxyphenyl)phosphine).

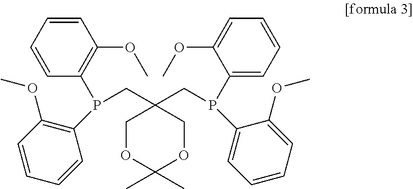

((2,2-dimethyl-1,3-dioxane-5,5-diyl)bis(methylene))bis(bis(2-methoxyphenyl)phosphine) of formula 3 shows the same activity expression as 3,3-bis-[bis-(2-methoxyphenyl)phosphonylmethyl]-1,5-dioxa-spiro[5,5]undecane which is known as showing highest activity among polyketone polymerization catalyst introduced until now, and the structure is simpler and molecular weight is lower. Therefore, the present invention obtains highest activity as polymerization catalyst in relevant field, and providing novel polyketone polymerization catalyst with lower manufacturing cost and production cost. Manufacturing method of ligand for polyketone polymerization catalyst is as follows. Using bis(2-methoxyphenyl)phosphine, 5,5-bis(bromomethyl)-2,2-dimethyl-1,3-dioxane and sodium hydride (NaH) and obtaining ((2,2-dimethyl-1,3-dioxane-5,5-diyl)bis(methylene))bis(bis(2-methoxyphenyl)phosphine) features manufacturing method of ligand for polyketone polymerization catalyst. Manufacturing method of ligand for polyketone polymerization catalyst of the present invention is different from conventional synthesis method of 3,3-bis-[bis-(2-methoxyphenyl)phosphonylmethyl]-1,5-dioxa-spiro[5,5]undecane as under safe environment not using lithium through simple process, ((2,2-dimethyl-1,3-dioxane-5,5-diyl)bis(methylene))bis(bis(2-methoxyphenyl)phosphine) can be commercially mass-synthesized.

In a preferred embodiment, manufacturing method of ligand for polyketone polymerization catalyst of the present invention goes through (a) a step of inserting bis(2-methoxyphenyl)phosphine and dimethylsulfoxide (DMSO) to reaction vessel under nitrogen atmosphere and adding sodium hydride in room temperature and stirring; (b) a step of adding 5,5-bis(bromethyl)-2,2-dimethyl-1,3-dioxane and dimethylsurfoxide to obtained mixed solution and stirring and reacting; (c) a step of inserting methanol and stirring after completing reaction; (d) a step of inserting toluene and water after separating layer, cleaning oil layer with water and drying with anhydrous sodium sulfate, pressure filtering and pressure concentration; and (e) a step of recrystallizing residue under methanol and obtaining ((2,2-dimethyl-1,3-dioxane-5,5-diyl)bis(methylene))bis(bis(2-methoxyphenyl)phosphine).

The amount of Group 9, Group 10, or Group 11 transition metal compound (a) differs suitable value according to selected ethylenically and propylenically unsaturated compound type or different polymerization condition, so the range is not uniformly limited, but conventionally capacity of reaction zone is 0.01 to 100 mmol per liter, and preferably 0.01 to 10 mmol. Capacity of reaction zone refers to capacity of liquid phase of reactor. The amount of ligand (b) is not limited, but transition metal compound (a) per 1 mol is conventionally 0.1 to 3 mol and preferably 1 to 3 mol.

Moreover, adding benzophenone could be another feature in polymerization of the polyketone.

In the present invention, in polymerization of polyketone by adding benzophenone, it can achieve effects of enhancing intrinsic viscosity of polyketone. The (a) Group 9, Group 10 or Group 11 transition metal compound and benzophenone molar ratio is 1:5 to 100, preferably 1:40 to 60. If transition metal and benzophenone molar ratio is less than 1:5, effects of enhancement in intrinsic viscosity of polyketone is not satisfactory, and if transition metal and benzophenone molar ratio is more than 1:100, catalyst activity of produced polyketone tends to decrease therefore not preferable.

Examples of ethylenically unsaturated compound polymerized with carbon monoxide are ethylene, propylene, 1-butene, 1-hexene, 4-methyl-1-pentene, 1-octene, 1-decene, 1-dodecene, 1-tetradecene, 1-hexadecene, α-olefin such as vinyl cyclohexane; alkenyl aromatic compound such as styrene, α-methyl styrene; cyclopentane, norbornene, 5-methyl norbornene, tetracyclododecene, tricyclo dodecane, tricyclo undecene, pentacyclopentadecene, pentacyclohexadecene, 8-ethyltetracyclododecene; halogenation vinyl such as vinyl chloride; acrylic ester such as ethyl acrylate and methyl acrylate. Among them preferable ethylenically unsaturated compound is α-olefin, and more preferably α-olefin with carbon number of 2 to 4, and most preferably ethylene, in terms of producing terpolymer polyketone inserting 120 mol % of propylene.

In this case, adjusting carbon monoxide and ethylenically unsaturated compound inserting ratio to 1:12 (molar ratio), and adjusting propylene to 120 mol % to the total mixed gas are preferable. In case of manufacturing polyketone, it is general to make carbon monoxide and ethylenically unsaturated compound inserting ratio to 1:1, but in the present invention wherein acetate and water is used as mixed solvent for liquid medium and adding benzophenone in polymerization, in the case of making carbon monoxide and ethylenically unsaturated compound inserting ratio to 1:12 and adjusting propylene 120 mol % to the total mixed gas not only enhances processability but also simultaneously achieves enhancement in catalyst activity and intrinsic viscosity. In case of the inserting amount of propylene is less than 1 mol %, it can no attain effects of terpolymer to lower melting temperature, and in the case of the inserting amount of propylene is more than 20 mol %, problem occurs such as impediment in enhancing intrinsic viscosity and catalyst activity, so it is preferable to adjust inserting ratio to 120 mol %.

Moreover, in the polymerization process, for liquid medium, mixed solvent of acetate and water is used, and adding benzophenone in polymerization, and by inserting carbon monoxide and ethylenically unsaturated compound and one or more olefin-based unsaturated compound not only polyketone catalyst activity and intrinsic viscosity enhance but also it is possible to produce terpolymer polyketone having high intrinsic viscosity by setting polymerization time for 12 hours, and this is different from conventional technology which set polymerization time for at least 10 hours to enhance intrinsic viscosity.

Terpolymer of carbon monoxide, the ethylenically unsaturated compound and propylenically unsaturated compound occurs by organic metal complex catalyst comprising the Group 9, Group 10 or Group 11 transition metal compound (a), ligand having Group 15 element (b), and the catalyst is formed by contacting to the 2 component. Contacting method can be selected arbitrary. In other words, among suitable solvent, solution mixed 2 component in advance can be used, or each 2 component can separately be provided to polymerization system and contact in polymerization system.

In the present invention, to improve a processability and physical properties of the polymer, conventionally known additives such as an antioxidant, a stabilizer, a filler, a refractory material, a releasing agent, a coloring agent and other materials may be additionally added.

Examples of a polymerization method include a solution polymerization method using a liquid medium, a suspension polymerization method, a vapor phase polymerization method in which a small amount of a polymer is impregnated with a high concentration catalyst solution, and etc. The polymerization may be either batch or continuous. The reactor used for the polymerization may be a known reactor as it is, or may be used by processing. Polymerization temperature is not particularly limited, and is generally 40 to 180° C., preferably 50 to 120° C. Polymerization pressure is not particularly limited, but is generally from atmospheric pressure to 20 MPa, preferably from 4 to 15 MPa.

Number average molecular weight measured by gel penetration chromatography is preferably 100 to 200,000 especially 20,000 to 90,000 of polyketone polymer. Physical properties of polymer according to molecular weight, according to whether polymer is copolymer or terpolymer, or in case of terpolymer, it is determined according to properties of the second hydrocarbon portion. Polymer used in the present invention has conventional melting point of 175° C. to 300° C., and generally 210° C. to 270° C. Limiting Viscosity Number (LVN) of polymer measured by using standard viscosity measuring device with HFIP (Hexafluoroisopropylalcohol) in 60° C. is 0.5 dl/g to 10 dl/g, and preferably 1 dl/g to 2 dl/g. In case of limiting viscosity number of polymer is less than 0.5, polyketone mechanical properties and chemical properties decline, and in case of limiting viscosity number of polymer is more than 10, moldability declines.

Meanwhile, polyketone molecular weight distribution is preferably 1.5 to 2.5, more preferably 1.8 to 2.2. If molecular weight distribution is less than 1.5, polymerization transference number declines, and if molecular weight distribution is more than 2.5, moldability declines. In order to adjust the molecular weight distribution adjusting proportionately according to palladium catalyst amount and polymerization temperature is possible. In other words, if palladium catalyst amount increases, or polymerization temperature is more than 100° C., molecular amount distribution increases.

Linear alternative polyketone is formed according to polymerization method stated above.

The wear resistant agent of the present invention is described below.

The polyketone molded component excellent in wear resistance according to the present invention is comprising a polyketone excellent in heat resistance, chemical resistance, fuel permeation resistance, and impact resistance; and a wear resistant agent of a specific material which reduces wear, thereby it is possible to remarkably improve the wear resistance of the polyketone because of the wear resistant agent of the specific material dispersed in the polyketone, especially the wear resistant agent of the specific material dispersed on a surface.

Also, the wear resistant agents of the specific materials added in order to improve friction resistance and wear resistance of polyketone molded components include at least one or more kinds selected from a group comprising silicon, polytetrafluorethylene (PTFE), calcium carbonate (CaCO₃), maleic acid, Molybdenum (Mo), glass fiber, magnesium stearate, and etc., more preferably silicon, polytetrafluoroethylene or magnesium stearate, and most preferably, silicon or polytetrafluoroethylene.

More specifically, the silicon may be provided in a form of a gum (product of a liquid type silicon produced by POM master batch) or powder, and after added to the polyketone, it might be dispersed in the polyketone through blending or etc.

The polytetrafluorethylene (PTFE) may be provided in a powder form, and after added to the polyketone, it might be dispersed in the polyketone through blending or etc.

The calcium carbonate (CaCO₃) may be provided in a powder form of a product used as a lubricant for engineering plastics, and after added to the polyketone, it might be dispersed in the polyketone through blending or etc.

The maleic acid may be provided in a form of an MA-g-ethylene copolymer substituted with maleic acid by graft polymerization of maleic acid to an ethylene copolymer, and after added to the polyketone, it might be dispersed in the polyketone through blending or etc.

The molybdenum (Mo) may be provided in a powder form of a metallized product family of molybdenum disulfide (MoS2), and after added to the polyketone, it might be dispersed in the polyketone through blending or etc.

The glass fiber preferably has a particle diameter of 10 to 13 μm. If the particle diameter of the glass fiber is less than 10 μm, a shape of the glass fiber may be changed and mechanical properties may decline.

The magnesium stearate may be provided in a powder form of a lubricant product, and after added to the polyketone, it might be dispersed in the polyketone through blending or etc.

In the polyketone molded component having excellent wear resistance according to the present invention, a polyketone content based on total composition weight is preferably 80 to 99.9 weight % and wear resistant agent of the specific material is preferably 0.1 to 20 weight %. If the content of the polyketone is less than 80 weight %, mechanical properties, thermal stability and fluidity of the molded component may be reduced. If the content is 99.9 weight % or more, the content of the wear resistant agent of the specific material is relatively small, thereby an effect of improving the wear resistance of the polyketone molded component may not enough.

Also, if content of the wear resistant agent of the specific material is less than 0.1 weight %, an effect of improving the wear resistance of the molded component may be insignificant. If the content is more than 20 weight %, the mechanical properties and thermal stability of the molded component decline, exfoliation may occur on a surface of the molded component.

According to an exemplary embodiment of the present invention, a silicone resin is 0.1 to 15 parts by weight of a silicone resin relative to 100 parts by weight of the polyketone resin. When the content of the silicone resin is less than 0.1, wear resistance is not enough when used as a gear, and when the content is more than 15, mechanical properties inherent to polyketone decline.

The silicone resin used in the present invention is in a powder form and preferably has a diameter of 1 to 2 μm, and if it is out of the range, blending with the polyketone is not smooth.

Also, the polyketone molded component of the present invention can be used in industrial fields requiring wear resistance, and is preferably applicable to wear parts in OA, ATM gear, electric/electronic gear, city gas meter gear or laser printer toner gear, however the present invention is not limited thereto.

Polyketone polymer of the present invention is polyketone copolymer of y/x 0.003 to 0.3, x and y in the following formula indicate each mol % in polymer.

—(CH₂CH₂—CO)x- formula (1)

—(CH₂CH(CH₃)—CO)y- formula (2)

Copolymer comprising repeating unit shown as formula (1) and (2) of the present invention, y/x is preferably 0.03 to 0.3. If the y/x is less than 0.03, there are limits such as melting property and processability decline, and if the y/x is more than 0.3, mechanical properties decline. Moreover, y/x is more preferably 0.03 to 0.1. Also, melting point of polymer can be adjusted by adjusting ratio of ethylene and propylene of polyketone polymer. For example, in case of molar ratio of ethylene:propylene:carbon monoxide is adjusted to 46:4:50, melting point is approximately 220° C., and if molar ratio is adjusted to 47.3:2.7:50, melting point is adjusted to 235° C.

The polyketone of the present invention can be used for industrial parts such as gears, microwave containers, cams, helmet gears for electric welding, plastic boards, yarn guides, bedding cleaner cams, office supplies and etc. Particularly when it is intended to be used as an industrial part, a wear resistant agent may be added to enhance wear resistance and impact resistance of the polyketone. The wear resistant agent is preferably selected from a group comprising ricons, polytetrafluoroethylene, calcium carbonate, maleic acid, molybdenum, glass fibers and magnesium stearate.

The wear resistance agent is preferably 0.1 to 20 parts by weight based on 100 parts by weight of the polyketone polymer based on a weight ratio. If the content of the wear resistant agent is less than 0.1, an effect of improving wear resistance and impact resistance is insignificant. If it is more than 20 parts by weight, mechanical properties, thermal stability and fluidity inherent to the polyketone may decline or exfoliation may occur on a surface.

The present invention also provides a window drum for automobiles, a sun visor retainer for automobiles, a safety belt jointer for automobiles, a auto gear slide for automobiles, a door latch housing for automobiles, a slide guide for automobiles, a switch shaft in heating, ventilation and air conditioning (HAVC) systems for automobiles, an actuator gear for automobiles, a trim mounting clip for automobiles, a cup holder for automobiles, a roof rack for an automobiles, and an air intake garnish for automobiles manufactured by injection molding a polyketone composition comprising a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0.

In this case, the polyketone composition preferably further comprises at least one kind selected from a group comprising a silicon-based wear resistant agent, glass fiber, and polytetrafluoroethylene resin. Here, the silicon-based wear resistant agent is preferably 2 to 20 weight % based on 100 weight % of total polyketone composition.

Also, the present invention provides a method for being manufactured by injection molding a blend comprising 60 to 95 weight % of a linear alternating polyketone polymer comprising carbon monoxide and at least one kind of olefinically unsaturated hydrocarbon and having a residual amount of palladium catalyst of 5 to 50 ppm and a molecular weight distribution of 1.5 to 3.0, and 40 weight % of glass fiber.

In addition, in case of an outside door handle for automobiles, the glass fiber is 5 to 30 weight % based on total blend, and the mineral filler is 10 to 20 weight %.

In this case, the glass fibers preferably have a particle diameter of 10 to 15 μm, but the present invention is not limited thereto. If the particle diameter of the glass fiber is less than 10 μm, a shape of the glass fiber may be changed and mechanical properties may decline.

Also, a composition ratio of the glass fiber to entire composition is preferably 5 to 40 weight %. If the composition ratio of the glass fiber is less than 5 weight %, mechanical stiffness may decline. If it is more than 40 weight %, extrusion and injection processability may decline.

Also, the mineral filler is one selected from a group comprising Talc, Kaolin, Mica, wollastonite, TiO2-coated mica platelets, silica, alumina, borosilicates, and oxides.

In this case, content of the mineral filler is 10 to 20 weight %. If the content of the mineral filler added is less than 10 weight %, dimensional stability declines. If it is more than 20 weight %, injection moldability declines.

Hereinafter, a manufacturing method for manufacturing a window drum for automobiles, a sun visor retainer for automobiles, a door frame inner cover for automobiles, a safety belt jointer for automobiles, an auto gear slide for automobiles, a door latch housing for automobiles, a slide guide for automobiles, a switch shaft in heating, ventilation and air conditioning (HAVC) systems for automobiles, an air intake opening garnish for an automobile, the HAVC switch and cam shaft, an actuator gear for automobiles, a trim mounting clip for automobiles, a cup holder for automobiles, a roof rack for automobiles, an outside door handle for automobiles, and an air intake garnish for automobiles according to the present invention is described.

The manufacturing method for manufacturing a window drum for automobiles, a sun visor retainer for automobiles, a door frame inner cover for automobiles, a safety belt jointer for automobiles, an auto gear slide for automobiles, a door latch housing for automobiles, a slide guide for automobiles, a switch shaft in heating, ventilation and air conditioning (HAVC) systems for automobiles, an air intake opening garnish for an automobile, the HAVC switch and cam shaft, an actuator gear for automobiles, a trim mounting clip for automobiles, a cup holder for automobiles, a roof rack for automobiles, an outside door handle for automobiles, and an air intake garnish for automobiles according to the present invention is comprising a step of preparing a catalyst composition comprising a palladium compound, an acid having a pKa value of 6 or less, and a phosphorus compound; a step of preparing a mixed solvent (polymerization solvent) comprising an alcohol (e.g., methanol) and water; a step of conducting a polymerization in a presence of the catalyst composition and the mixed solvent to prepare a linear terpolymer of carbon monoxide, ethylene and propylene; a step of removing a remaining catalyst composition from the linear terpolymer with a solvent (e.g., alcohol and acetone) to obtain a polyketone polymer; and a step of injection molding the polyketone composition including the polyketone polymer and a silicon-based wear resistant agent, but the present invention is not limited thereto.

In this case, based on 100 weight % of total polyketone composition, the silicon-based wear resistant agent is preferably 2 to 20 weight %, but is not limited thereto.

For the palladium compound comprising the catalyst composition, palladium acetate can be used, and the amount is preferably 10⁻³ to 10⁻¹ mol, but it is not limited thereto.

In addition, for acid having 6 or less pKa value comprising the catalyst composition is in group of trifluoro acetate, p-toluenesulfonic acid, sulfuric acid, and sulfonic acid, one or more kind selected, preferably trifluoro acetate can be used, and the amount is preferably 6 to 20 mol equivalent to palladium compound.

Moreover, bidentate ligand compound of the phosphorous comprising the catalyst composition is any one selected in group of 1,3-bis[diphenylphosphino]propane, 1,3-bis[di(2-methoxyphenylphosphino)]propane, 1,3-bis[bis[anisyl]phosphinomethyl-1,5-dioxaspiro[5,5]undecane, and ((2,2-dimetyl-1,3-dioxane-5,5-diyl)bis(methylene))bis(bis(2-methoxyphenyl)phosphine), and the amount is preferably 1 to 20 (mol) equivalent to palladium compound.

The carbon monoxide, ethylene and propylene liquefied polymerized in mixed solvent of alcohol (for example, methanol) and water, and produces linear terpolymer, for the mixed solvent, methanol 100 parts by weight and water 2 to 10 parts by weight can be used. If content of water in mixed solvent is less than 2 parts weight, ketal is formed and thermal stability can be declined in process, and if it is more than 10 parts by weight, mechanical properties of product can be declined.

Also, in the polymerization, reaction temperature is preferably 50 to 100° C. and reaction pressure is preferably 40 to 60 bar. Produced polymer is retrieved through filtering and cleaning process after polymerization, and remained catalyst composition is removed by solvent such as alcohol or acetone.

In the present invention, it can be manufactured by melt-kneading and extruding inserting a polyketone composition comprising the obtained polyketone polymer; and one or more kinds selected from a group comprising a silicon-based wear resistant agent, glass fiber and polytetrafluoroethylene resin into an extruder using a biaxial screw.

In this case, extrusion temperature is preferably 230 to 260° C., and a screw rotating speed is preferably in a range of 100 to 300 rpm. If the extrusion temperature is less than 230° C., kneading may not occur properly, and if the extrusion temperature is more than 260° C., a problem relating to heat resistance of the resin may occur. If the screw rotating speed is less than 100 rpm, kneading may not be smoothly performed, and if the screw rotating speed is more than 300 rpm, mechanical properties may decline.

By manufacturing the blend by the method as above and extrusion molding or injection molding it, a window drum for automobiles, a sun visor retainer for automobiles, a door frame inner cover for automobiles, a safety belt jointer for automobiles, an auto gear slide for automobiles, a door latch housing for automobiles, a slide guide for automobiles, a switch shaft in heating, ventilation and air conditioning (HAVC) systems for automobiles, an air intake opening garnish for an automobile, the HAVC switch and cam shaft, an actuator gear for automobiles, a trim mounting clip for automobiles, a cup holder for automobiles, a roof rack for automobiles, an outside door handle for automobiles, and an air intake garnish for automobiles can be manufactured.

The air intake garnish for automobiles according to the present invention exhibits excellent wear resistance and dimensional stability. Specifically, the air intake garnish for automobiles has an impact strength of 20 kJ/m2 or more and a wear resistance of 1.0 mm3/kg/km or less in a base state.

In addition, the polyketone medical transportation tray, medical pipette, and refrigerator door closures of the present invention are made of polyketone. In this case, the polyketone medical transportation tray of the present invention may be made of a polyketone composition comprising one or more kinds selected from a group comprising a polyketone; a silicon-based wear resistant agent, glass fiber, and polytetrafluoroethylene resin, but is not limited thereto.

Also, the polyketone cellular phone polishing fixture of the present invention may comprise a polyketone composition comprising a polyketone and a polytetrafluoroethylene resin, but is not limited thereto.

In a method of polymerization of polyketone, wherein monomer units are alternating, thereby the polymer is composed of units of general formula —(CO)-A′- (Here, A′ represents a monomer unit derived from the applied monomer A), a high molecular weight linear polymer of one or more olefinically unsaturated compound (simply referred to as A) and carbon monoxide can be manufactured by contacting with a solution of a palladium-comprising catalyst composition in a diluent in which the polymer does not dissolve. During polymerization process, the polymer is obtained in a form of a suspension in the diluent. Polymer manufacture is performed primarily batchwise.

The batchwise manufacture of the polymer is usually carried out by inserting a catalyst into a reactor containing the diluent and the monomer and having a desired temperature and pressure. As the polymerization progresses, the pressure drops, as a concentration of the polymer in the diluent increases, and viscosity of the suspension increases. The polymerization is continued until the viscosity of the suspension reaches a high enough value to cause difficulty associated with heat removal. During batchwise polymer manufacture, if desired, by adding monomers to the reactor during the polymerization, it is possible to maintain the temperature as well as the pressure constant.

Hereinafter, a manufacturing method for manufacturing the polyketone medical transportation tray, the medical pipette, the refrigerator door closure, and the cellular phone polishing fixture is described.

A manufacturing method for manufacturing a polyketone medical transportation tray, a medical pipette, a refrigerator door closure and a cellular phone polishing fixture of the present invention comprises: a step of preparing a catalyst composition comprising a palladium compound, an acid having a pKa value of 6 or less, and a bidentate compound of phosphorus; a step of preparing a mixed solvent (polymerization solvent) of acetic acid and water; a step of conducting a polymerization in presence of the catalyst composition and the mixed solvent to prepare a linear terpolymer of carbon monoxide, ethylene and propylene; a step of removing the remaining catalyst composition from the prepared linear terpolymer using a solvent (e.g., alcohol and acetone) to obtain a polyketone resin; and a step of mixing and extruding the polyketone resin.

For the palladium compound comprising the catalyst composition, palladium acetate can be used, and the amount is preferably 10⁻³ to 10⁻¹, but it is not limited thereto.

In addition, for acid having 6 or less pKa value comprising the catalyst composition is in group of trifluoro acetate, p-toluenesulfonic acid, sulfuric acid, and sulfonic acid, one or more kind selected, preferably trifluoro acetate can be used, and the amount is preferably 6 to 20 mol equivalent to palladium compound.

The bidentate compound of phosphorus comprising the catalyst composition is preferably ((2,2-dimethyl-1,3-dioxane-5,5-diyl)bis(methylene))bis(bis(2-methoxyphenyl)phosphine), and amount thereof is preferably 1 to 1.2 (mol) relative to the palladium compound.

The carbon monoxide, ethylene and propylene liquefied polymerized in mixed solvent of alcohol (for example, methanol) and water, and produces linear terpolymer, for the mixed solvent, acetic acid 100 parts by weight and water 2 to 30 parts by weight can be used. If content of water in mixed solvent is less than 2 parts weight, ketal is formed and thermal stability can be declined in process, and if it is more than 30 parts by weight, mechanical properties of product can be declined.

Also, in the polymerization, reaction temperature is preferably 50 to 100° C. and reaction pressure is preferably 40 to 60 bar. Produced polymer is retrieved through filtering and cleaning process after polymerization, and remained catalyst composition is removed by solvent such as alcohol or acetone.

In the present invention, the obtained polyketone resin is extruded by an extruder to finally obtain a blend composition. The blend is produced by putting into an extruder using a biaxial screw, melt-kneading and extruding.

In this case, extrusion temperature is preferably 230 to 260° C., and screw rotating speed is preferably in a range of 100 to 300 rpm. If the extrusion temperature is less than 230° C., kneading may not occur properly, and if the extrusion temperature is more than 260° C., a problem relating to heat resistance of the resin may occur.

The polyketone medical transportation tray, the medical pipette, the refrigerator door closure, and the cellular phone polishing fixture can be manufactured by manufacturing the resin and injecting it by the above-described method.

The polyketone medical transportation tray, the medical pipette, the refrigerator door closure, and the cellular phone polishing fixture manufactured according to the present invention were found to have excellent wear resistance.

Hereinafter, the present invention is described in more detail with reference to the following examples. However, the following examples are illustrative of the present invention and are not to be construed as limiting the scope of the present invention. The present invention is illustrated in detail by following non-limiting examples.

### Example 1

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, and MI (Melt Index) was 48 g/10 min. 90 weight % of the polyketone terpolymer prepared above and 10 weight % of silicone were molded into pellets on an extruder using a biaxial screw having a diameter of 2.5 cm and L/D=32, which was operated at 250 rpm, and then injection molded to produce a specimen for a wear part in OA.

### Example 2

The same as Example 1 except that the polyketone composition was composed of 90 weight % of polyketone and 10 weight % of polytetrafluoroethylene.

### Example 3

The same as Example 1 except that the polyketone composition was composed of 90 weight % of polyketone and 10 weight % of glass fiber.

### Example 4

The same as Example 1 except that the polyketone composition was composed of 97 weight % of polyketone and 3 weight % of silicone.

### Comparative Example 1

The same as Example 1 except that 100 weight % of polyketone was used.

### Comparative Example 2

The same as Example 1 except that 100 weight % of polyoxymethylene was used.

### Comparative Example 3

The same as Example 1 except that 100 weight % of nylon 66 was used.

### Comparative Example 4

The same as Example 1 except that 90 weight % of polyoxymethylene and 10 weight % of silicone were used.

### Properties Evaluation

wear amount and wear length of the specimens prepared in Examples and Comparative Examples were measured under experimental conditions of a speed of 50 rpm, a load of 150 N and a wear distance of 3 km, and results are shown in Table 1.

TABLE 1

| | | Wear | Wear |
|---|---|---|---|
| | | amount | length |
| | Composition ratio | (g) | (mm) |
| Example 1 | polyketone 90%/silicone 10% | 0.0031 | 0.012 |
| Example 2 | polyketone 90%/ | 0.0033 | 0.013 |
| | polytetrafluoroethylene 10% | | |
| Example 3 | polyketone 90%/glass fiber 10% | 0.0040 | 0.015 |
| Example 4 | polyketone 97%/silicone 3% | 0.0027 | 0.011 |
| Comparative | polyketone 100% | 0.0150 | 0.060 |
| Example 1 | | | |
| Comparative | polyoxymethylene 100% | 0.0610 | 0.630 |
| Example 2 | | | |
| Comparative | polyoxymethylene 90%/silicone 10% | 0.0530 | 0.615 |
| Example 3 | | | |
| Comparative | nylon66 100% | 0.0070 | 0.025 |
| Example 4 | | | |

As shown in Table 1, the polyketone molded components produced by blending [symbol] polyketone with wear resistant agent such as silicone, polytetrafluoroethylene, glass fiber and silicone exhibited a wear amount of 0.005 g or less under same test conditions as those of the comparative examples, thereby it is suitable for wear parts in OA, ATM gear, electric/electronic gear, city gas meter gear and laser printer toner gear which are required to have wear resistance.

### Example 5

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.0, and a residual amount of palladium catalyst was 5 ppm. The polyketone terpolymer prepared above was molded into pellets on an extruder using a biaxial screw having a diameter of 40 mm and L/D=32, which was operated at 250 rpm, and then injection molded to produce a specimen for a microwave container.

### Example 6

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 74° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.6 dl/g, MI (Melt Index) was 60 g/10 min, MWD was 2.0, and a residual amount of palladium catalyst was 5 ppm. The polyketone terpolymer prepared above was molded into pellets on an extruder using a biaxial screw having a diameter of 40 mm and L/D=32, which was operated at 250 rpm, and then injection molded to produce a specimen for a microwave container.

### Example 7

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 9 times the molar ratio, and two stages of the first stage at a polymerization temperature of 72° C. and the second stage at 78° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 2.0 dl/g, MI (Melt Index) was 60 g/10 min, MWD was 2.0, and a residual amount of palladium catalyst was 7 ppm. The polyketone terpolymer prepared above was molded into pellets on an extruder using a biaxial screw having a diameter of 40 mm and L/D=32, which was operated at 250 rpm, and then injection molded to produce a specimen for a microwave container.

### Comparative Example 5

A specimen of a microwave container was produced with polytetrafluoroethylene resin.

### Properties Evaluation

A coefficient of kinetic friction, wear property and impact strength of the specimens respectively prepared in Examples 5 to 7 and Comparative Example 5 were evaluated by following method. Results are shown in Table 2.

The coefficient of kinetic friction is a measure of a degree of kinetic friction, it means that the greater the coefficient of kinetic friction, the greater the frictional force, and the smaller the value, the smaller the frictional force.

The wear property is a value indicating a degree of wear. The larger the wear property, the smaller the wear resistance because wear occurs more easily. Meanwhile, the smaller the wear property, the greater the wear resistance because wear does not occur easily. A wear test was carried out by a pin-on-disk type under a load of 1 kg, a linear velocity of 7 Hz and a test time of 30 minutes.

TABLE 2

| | | | | Comparative |
|---|---|---|---|---|
| Item | Example 5 | Example 6 | Example 7 | Example 5 |
| Coefficient of kinetic | 0.10 | 0.15 | 0.12 | 0.40 |
| friction | | | | |
| Wear property | 0.60 | 0.65 | 0.70 | 8.10 |
| (Rmax) | | | | |

As can be seen from Table 2, impact strength of the example was improved compared to comparative example, the coefficient of kinetic friction and the wear property were small, thereby the frictional force was small and the wear resistance was improved.

### Example 8

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.2 dl/g, MI (Melt Index) was 60 g/10 min, MWD was 2.0.

The polyketone terpolymer prepared above was extruded through melt-kneading on an extruder using a biaxial screw having L/D32 and D 40 at 240° C., which was operated at 250 rpm.

### Example 9

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.0.

The polyketone terpolymer prepared above was extruded through melt-kneading on an extruder using a biaxial screw having L/D32 and D 40 at 240° C., which was operated at 250 rpm.

### Example 10

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 9 times the molar ratio, and two stages of the first stage at a polymerization temperature of 74° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.6 dl/g, MI (Melt Index) was 60 g/10 min, MWD was 2.0.

The polyketone terpolymer prepared above was extruded through melt-kneading on an extruder using a biaxial screw having L/D32 and D 40 at 240° C., which was operated at 250 rpm.

### Example 11

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 1.8.

The polyketone terpolymer prepared above was extruded through melt-kneading on an extruder using a biaxial screw having L/D32 and D 40 at 240° C., which was operated at 250 rpm.

### Example 12

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.2.

The polyketone terpolymer prepared above was extruded through melt-kneading on an extruder using a biaxial screw having L/D32 and D 40 at 240° C., which was operated at 250 rpm.

### Comparative Example 6

The same as Example 1 except that a polyoxymethylene resin was used in place of the polyketone copolymer.

### Properties Evaluation

The prepared pellets of the above examples were injection-molded to produce specimens for chair cams. Specific gravity, wear resistance, and impact resistance were evaluated in following method in comparison with the specimens of the comparative examples, and results are shown in Table 3.
1. Wear resistance evaluation: The moldings prepared in Examples and Comparative Examples were processed into a disk shape (120 mm in diameter and 2 mm in thickness) and left at 25° C. for 2 days. Then, a Taber wear tester (manufactured by DAITO ELECTRON CO., LTD., conditions: a load of 1 kg, wear wheel H-22) was used to measure a wear amount according to JIS K-7311.
2. Izod impact strength: Evaluated about ASTM D256, ¼ inch thick specimens at room temperature.
3. Noise measurement: While using the wear resistance evaluation device of 1., noise was measured by a portable noise measurement device.

TABLE 3

| | Example | Example | Example | Example | Example | Comparative |
|---|---|---|---|---|---|---|
| Item | 8 | 9 | 10 | 11 | 12 | Example 6 |
| Specific gravity | 1.24 | 1.22 | 1.24 | 1.23 | 1.22 | 1.42 |
| Wear resistance | 18 | 20 | 19 | 22 | 20 | 44 |
| wear amount | | | | | | |
| (mg) | | | | | | |
| Izod impact | 42 | 40 | 44 | 38 | 42 | 44 |
| strength | | | | | | |
| (kg · cm/cm) | | | | | | |
| Noise level during | 60 | 62 | 61 | 63 | 65 | 80 |
| wear | | | | | | |
| measurement(dB) | | | | | | |

As shown in Table 1, in Examples 8 to 12, it was evaluated as being superior in light weight, wear resistance, impact resistance and noise generation as compared with Comparative Example 6, thereby it is proved to be suitable for use as a chair cam.

In the present invention, when measured by the above method, the wear amount is 25 mg or less and the noise generation amount is 70 dB or less.

### Example 13

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.2 dl/g, MI (Melt Index) was 60 g/10 min, MWD was 2.0.

The polyketone copolymer prepared above was placed in a mold and injection molded at 70 bar, a temperature of 250° C. and a mold temperature of 150° C. to produce a gear.

### Example 14

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.0.

The polyketone copolymer prepared above was placed in a mold and injection molded at 70 bar, a temperature of 250° C. and a mold temperature of 150° C. to produce a gear.

### Example 15

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 9 times the molar ratio, and two stages of the first stage at a polymerization temperature of 74° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.6 dl/g, MI (Melt Index) was 60 g/10 min, MWD was 2.0.

The polyketone copolymer prepared above was placed in a mold and injection molded at 70 bar, a temperature of 250° C. and a mold temperature of 150° C. to produce a gear.

### Example 16

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 1.8.

The polyketone copolymer prepared above was placed in a mold and injection molded at 70 bar, a temperature of 250° C. and a mold temperature of 150° C. to produce a gear.

### Example 17

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.2.

The polyketone copolymer prepared above was placed in a mold and injection molded at 70 bar, a temperature of 250° C. and a mold temperature of 150° C. to produce a gear.

### Comparative Example 7

The same as Example 13 except that a high impact nylon 66 was used in place of the polyketone copolymer.

### Properties Evaluation

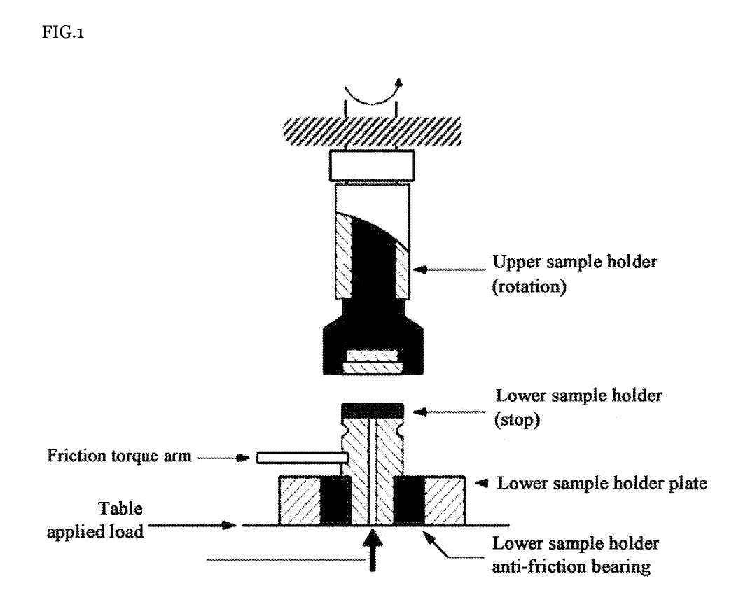

1. Dimensional stability evaluation: Product strain rate was evaluated according to MS211-47 for vertical and horizontal directions at a temperature of 50° C. and a relative humidity of 90%.
2. Wear resistance evaluation: Weight loss was calculated at 25° C. using a thrust washer test device shown in FIG. 1 for the plastic gear manufactured according to the Examples, and then wear coefficient (K_{LNP}) was calculated by a following equation.

$${K}_{LNP} = \frac{W}{PVT}$$

(V=velocity (ft./min.), P=pressure (lbs./in2), T=elapsed time (hrs) and W is weight loss divided by density, thereby it means an wear amount per unit volume.)
3. Moisture resistance evaluation: The polyketone copolymer prepared in Example 13 to 17 and a nylon 66 of DuPont were separately inserted into an extruder using a biaxial screw having L/D32 and D 40, and extruded through melt-kneading at 240° C. and screw rotating speed of 250 rpm to produce pellets. The produced pellets were left in 85° C./85% thermo-hygrostat for 48 hours, and water content rate for 20 minutes of the pellets was measured using a Mettler HR-83.
4. Driving evaluation: After the helmet gears manufactured in Examples and Comparative examples were mounted on a helmet, an evaluation was made to drive an inside of a face part and a number of times the gears endured was measured.

TABLE 4

| | Example | Example | Example | Example | Example | Comparative |
|---|---|---|---|---|---|---|
| Item | 13 | 14 | 15 | 16 | 17 | Example 7 |
| Product strain rate- | 0.22 | 0.24 | 0.20 | 0.21 | 0.18 | 0.34 |
| vertical | | | | | | |
| (50° C., RH 90%) | | | | | | |
| Product strain rate- | 0.08 | 0.12 | 0.10 | 0.08 | 0.10 | 0.25 |
| horizontal | | | | | | |
| (50° C., RH 90%) | | | | | | |
| wear coefficient | 250 | 240 | 260 | 240 | 250 | 450 |
| K_{LNP} | | | | | | |
| Moisture resistance | 0.31 | 0.34 | 0.28 | 0.32 | 0.40 | 3.2 |
| Driving | 300,025 | 298,025 | 300,245 | 299,031 | 300,025 | 150,140 |
| evaluation(number | | | | | | |
| of times) | | | | | | |

From Table 4, it can be seen that the polyketone resin in a base state of the present invention is superior in property maintenance rate, wear resistance (wear coefficient of 200 to 300) and moisture resistance as compared with high impact polyamide. Therefore, the helmet gear for electric welding manufactured from the polyketone resin of the present invention can solve a problem that a face protection cover of the helmet for electric welding can easily flow down, because it is less worn than conventional polyamide gear.

### Example 18

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.2 dl/g, MI (Melt Index) was 60 g/10 min, MWD was 2.0.

The polyketone terpolymer was solidified in a plate shape at a room temperature to a thickness corresponding to a gear thickness, and in the solidified plastic board, a gear of a required size were molded by blanking to produce a gear.

### Example 19

After produced the polyketone terpolymer in a same method as Example 18, 100 parts by weight of the polyketone terpolymer and 1 part by weight of silicone resin were mixed and solidified in a plate shape at a room temperature to a thickness corresponding to a gear thickness, and in the solidified plastic board, a gear of a required size were molded by blanking to produce a gear.

### Example 20

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.0.

The polyketone terpolymer was solidified in a plate shape at a room temperature to a thickness corresponding to a gear thickness, and in the solidified plastic board, a gear of a required size were molded by blanking to produce a gear.

### Example 21

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 2.0 dl/g, MI (Melt Index) was 60 g/10 min, MWD was 2.0.

The polyketone terpolymer was solidified in a plate shape at a room temperature to a thickness corresponding to a gear thickness, and in the solidified plastic board, a gear of a required size were molded by blanking to produce a gear.

### Example 22

After produced the polyketone terpolymer in a same method as Example 20, 100 parts by weight of the polyketone terpolymer and 5 parts by weight of silicone resin were mixed and solidified in a plate shape at a room temperature to a thickness corresponding to a gear thickness, and in the solidified plastic board, a gear of a required size were molded by blanking to produce a gear.

### Example 23

After produced the polyketone terpolymer in a same method as Example 20, 100 parts by weight of the polyketone terpolymer and 10 parts by weight of silicone resin were mixed and solidified in a plate shape at a room temperature to a thickness corresponding to a gear thickness, and in the solidified plastic board, a gear of a required size were molded by blanking to produce a gear.

### Comparative Example 8

The same as Example 18 except that POM was used as a material of Dupont in a base state in place of the polyketone copolymer.

### Properties Evaluation

1. Evaluation of dimensional stability, wear resistance, and impact resistance: The plastic panels produced in the above Examples and Comparative Examples were evaluated for dimensional stability, wear resistance and impact resistance by following methods.
1) Dimensional stability evaluation: Product strain rate was evaluated according to MS211-47 for vertical and horizontal directions at a temperature of 50° C. and a relative humidity of 90%.
2) Wear amount evaluation: Evaluation was made using a cylindrical specimen having an inner diameter of 20 mm, an outer diameter of 25 mm and a height of 15 mm and a counter material. Wear loss was measured at a speed of 50 rpm under a JIS K7218 standard, a load of 150 N, and a wear distance of 3 km.
3) Impact resistance evaluation: Evaluated about ASTM D256, ¼ inch thick specimens at room temperature.

TABLE 5

| | | | | | | | Comparative |
|---|---|---|---|---|---|---|---|
| | Example | Example | Example | Example | Example | Example | Example |
| Item | 18 | 19 | 20 | 21 | 22 | 23 | 8 |
| Product | 0.12 | 0.14 | 0.13 | 0.10 | 0.08 | 0.15 | 0.25 |
| strain rate- | | | | | | | |
| vertical | | | | | | | |
| (50° C., RH | | | | | | | |
| 90%) | | | | | | | |
| Product | 0.04 | 0.03 | 0.06 | 0.05 | 0.062 | 0.04 | 0.12 |
| strain rate- | | | | | | | |
| horizontal | | | | | | | |
| (50° C., RH | | | | | | | |
| 90%) | | | | | | | |
| Wear | 0.018 | 0.015 | 0.013 | 0.010 | 0.003 | 0.002 | 0.083 |
| amount (g) | | | | | | | |
| Izod | 33 | 35 | 30 | 60 | 28 | 22 | 22 |
| impact | | | | | | | |
| strength | | | | | | | |
| (kg · cm/cm) | | | | | | | |

The gears manufactured from the polyketone base or blend composition of the present invention of Example 18 to 23 are superior in product strain rate in vertical and horizontal directions as compared with the gears manufactured by a method of the comparative example and have excellent wear resistance.

Also, the present invention had a wear amount of 0.020 g or less, which is superior, when measured under JIS K7218 at a speed of 50 rpm, a load of 150 N and a wear distance of 3 km.

### Example 24

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.2 dl/g, MI (Melt Index) was 60 g/10 min, MWD was 2.0.

The polyketone terpolymer prepared above was extruded through melt-kneading on an extruder using a biaxial screw having L/D32 and D 40 at 240° C. and a screw rotating speed of 250 rpm to produce a specimen for manufacturing a yarn guide.

### Example 25

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.0.

The polyketone terpolymer prepared above was extruded through melt-kneading on an extruder using a biaxial screw having L/D32 and D 40 at 240° C. and a screw rotating speed of 250 rpm to produce a specimen for manufacturing a yarn guide.

### Example 26

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 9 times the molar ratio, and two stages of the first stage at a polymerization temperature of 74° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.6 dl/g, MI (Melt Index) was 60 g/10 min, MWD was 2.0.

The polyketone terpolymer prepared above was extruded through melt-kneading on an extruder using a biaxial screw having L/D32 and D 40 at 240° C. and a screw rotating speed of 250 rpm to produce a specimen for manufacturing a yarn guide.

### Example 27

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 1.8.

The polyketone terpolymer prepared above was extruded through melt-kneading on an extruder using a biaxial screw having L/D32 and D 40 at 240° C. and a screw rotating speed of 250 rpm to produce a specimen for manufacturing a yarn guide.

### Experimental Example 1

Specific gravity, wear resistance, chemical resistance and corrosion resistance of the specimens for the yarn guide produced by methods of Example 24 to 27 were measured and compared with physical properties of aluminum, and results are shown in Table 6. Physical properties are evaluated as follows.

### Properties Evaluation

1. Wear resistance evaluation: Specimens from the Examples were fabricated in a form of a disk (120 mm in diameter and 2 mm in thickness) and ceramic and aluminum specimens of a same type were produced and left at 25° C. for 2 days respectively, and then wear amount was measured using a Taber wear tester (DAITO ELECTRON CO., LTD., conditions: a load of 1 kg, a wear wheel H-22) according to JIS K-7311.
2. Chemical resistance evaluation: The specimens prepared from the Examples were cut into a size of 195 mm×19 mm×3 mm, and ceramic and aluminum specimens of a same size were prepared. The specimens were fixed on a jig for each strain, immersed in cyclopentane for 2 minutes, taken out and left for a minute, and JIG value of the strain without cracking was measured.
3. Corrosion resistance evaluation: Aqueous spray test was conducted by a method specified in ASTM B117 and then evaluated according to following criteria.
   Excellent: no white rust after 120 hours
   Good: less than 5% of white rust area after 120 hours
   Insufficient: 5% or more, less than 50% of white rust area after 120 hours
   Defective: 50% or more of white rust area after 120 hours
4. Full winding rate evaluation: Full winding rate was measured by a conventional method.
5. Frequency of occurrence of hairness evaluation: For a polyethylene multifilament, frequency of occurrence was evaluated according to a number of hairness per 100,000 m.

TABLE 6

| | Example | Example | Example | Example | |
|---|---|---|---|---|---|
| Item | 24 | 25 | 26 | 27 | aluminum |
| Specific gravity | 1.24 | 1.22 | 1.20 | 1.26 | 2.7 |
| (g/cm³) | | | | | |
| Wear resistance | 18 | 20 | 19 | 22 | 68 |
| wear amount (mg) | | | | | |
| Chemical | 3.5 | 3.2 | 3.4 | 3.5 | 1.8 |
| resistance | | | | | |
| (JIG value) | | | | | |
| Corrosion | Excellent | Excellent | Excellent | Excellent | Insufficient |
| resistance | | | | | |
| Full winding rate | 98 | 99 | 98 | 99 | 95 |
| (%) | | | | | |
| Number of | 1 | 1 | 1 | 1 | 4 |
| hairness | | | | | |
| (pieces/100000m) | | | | | |

Table 6 shows that the polyketone copolymer of the present invention is lighter than ceramic and aluminum and is suitable for being used as a material for a yarn guide because of its excellent wear resistance, chemical resistance, corrosion resistance, full winding rate and low frequency of occurrence of hairness.

### Example 28

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.2 dl/g, MI (Melt Index) was 60 g/10 min, MWD was 2.0. The polyketone terpolymer prepared above were molded into pellets on an extruder using a biaxial screw having a diameter of 40 mm and L/D=32, which was operated at 250 rpm, and then injection molded to produce a specimen for a microwave component.

### Example 29

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.0. The polyketone terpolymer prepared above were molded into pellets on an extruder using a biaxial screw having a diameter of 40 mm and L/D=32, which was operated at 250 rpm, and then injection molded to produce a specimen for a microwave component.

### Example 30

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 9 times the molar ratio, and two stages of the first stage at a polymerization temperature of 74° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.6 dl/g, MI (Melt Index) was 60 g/10 min, MWD was 2.0. The polyketone terpolymer prepared above were molded into pellets on an extruder using a biaxial screw having a diameter of 40 mm and L/D=32, which was operated at 250 rpm, and then injection molded to produce a specimen for a microwave component.

### Example 31

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 1.8. The polyketone terpolymer prepared above were molded into pellets on an extruder using a biaxial screw having a diameter of 40 mm and L/D=32, which was operated at 250 rpm, and then injection molded to produce a specimen for a microwave component.

### Example 32

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.2. The polyketone terpolymer prepared above were molded into pellets on an extruder using a biaxial screw having a diameter of 40 mm and L/D=32, which was operated at 250 rpm, and then injection molded to produce a specimen for a microwave component.

### Comparative Example 9

Specimens for microwave components were produced using PTFE, which was conventionally used as a material for microwave components.

### Properties Evaluation

The prepared pellets of the above Examples were injection-molded to prepare specimens for microwave components. Properties of the specimens were evaluated in following method in comparison with the specimens of the comparative examples, and results are shown in Table 1.
1. Izod impact strength evaluation: Performed according to ASTM D256.
2. Water absorption rate evaluation: Measurement of water content after treatment for 24 hours at a temperature of 50° C. and a relative humidity of 90%
3. Friction-wear resistance (Ring-on-Ring Type, large resin): A through-type test piece having an outer diameter of 25.6 mm, an inner diameter of 20 mm and a height of 15 mm is injection-molded, fixed to a test apparatus, and subjected to a test under a driving condition of a pressure load of 6.6 kgf and a linear velocity of 10 cm/s. In this case, non-wear amount was calculated using following formula to evaluate friction-wear resistance. The smaller the amount of non-wear obtained, the better the friction-wear resistance.

Non-wear amount=wear weight (mg)/[density (mg/mm3)×pressure load (kgf)×travel distance (km)]
test apparatus: Trust type friction-wear tester
4. Cycle time (injection moldability evaluation sec): Time taken for the pellets prepared in Examples or Comparative Examples to crystallize after melting was measured in sec.

Properties of Examples and Comparative Examples were as shown in Table 7.

TABLE 7

| | Example | Example | Example | Example | Example | Comparative |
|---|---|---|---|---|---|---|
| | 28 | 29 | 30 | 31 | 32 | Example 9 |
| Properties | IV: 1.2 | IV: 1.4 | IV: 1.6 | IV: 1.4 | IV: 1.4 | PTFE |
| | MWD: | MWD: | MWD: | MWD: | MWD: | |
| | 2.0 | 2.0 | 2.0 | 1.8 | 2.2 | |
| Izod impact | 14 | 12 | 11 | 13 | 15 | 6 |
| strength (kJ/m2) | | | | | | |
| Product water | 0.8 | 0.9 | 0.9 | 1.0 | 0.8 | 5.0 |
| absorption rate | | | | | | |
| (%, 50° C./90% RH) | | | | | | |
| wear resistance | 0.62 | 0.60 | 0.55 | 0.60 | 0.62 | 5.10 |
| (mm3/kg/km) | | | | | | |
| Injection cycle | 17 | 17 | 17 | 17 | 17 | 23 |
| (sec) | | | | | | |

As shown in Table 7, in the examples, the water absorption rate was lower than that of the comparative example, and the wear amount was also evaluated to be very low, thereby wear resistance was excellent. In addition, the injection cycle was short, thereby the injection moldability was excellent. Therefore, the polyketone microwave components manufactured by the examples of the present invention are well suited for application to microwave components having excellent impact resistance, wear resistance, moisture resistance, and injection moldability.

### Example 33

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.2 dl/g, MI (Melt Index) was 60 g/10 min, MWD was 2.0.

The polyketone terpolymer prepared above was extruded through melt-kneading on an extruder using a biaxial screw having L/D32 and D 40 at 240° C., which was operated at 250 rpm.

### Example 34

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.0.

The polyketone terpolymer prepared above was extruded through melt-kneading on an extruder using a biaxial screw having L/D32 and D 40 at 240° C., which was operated at 250 rpm.

### Example 35

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 9 times the molar ratio, and two stages of the first stage at a polymerization temperature of 74° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.6 dl/g, MI (Melt Index) was 60 g/10 min, MWD was 2.0.

The polyketone terpolymer prepared above was extruded through melt-kneading on an extruder using a biaxial screw having L/D32 and D 40 at 240° C., which was operated at 250 rpm.

### Example 36

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 1.8.

The polyketone terpolymer prepared above was extruded through melt-kneading on an extruder using a biaxial screw having L/D32 and D 40 at 240° C., which was operated at 250 rpm.

### Example 37

Under presence of catalyst composition formed from palladium acetate, trifluoroacetic acid and ((2,2-dimethyl-1,3-dioxane-5,5-diyl)bis(methylene)bis(2-methoxyphenyl) phosphine), linear alternating polyketone terpolymers comprising carbon monoxide and ethylene and propene are prepared. In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min, MWD was 2.2.

The polyketone terpolymer prepared above was mixed and extruded through melt-kneading on an extruder using a biaxial screw having L/D32 and D 40 at 240° C., which was operated at 250 rpm.

### Example 38

The same as Example 34 except that intrinsic viscosity of the polyketone was adjusted to 2.0 dl/g.

### Comparative Example 10

The same as Example 33 except that a polyoxymethylene resin was used in place of the polyketone copolymer.

### Properties Evaluation

The prepared pellets of the above Examples were injection-molded to prepare specimens for bedding cleaner. Scratch resistance and impact resistance of the specimens were evaluated by following method in comparison with the specimens of the comparative example. Results are shown in Table 8.
1. Wear resistance evaluation: The moldings prepared in Examples and Comparative Examples were processed into a disk shape (120 mm in diameter and 2 mm in thickness) and left at 25° C. for 2 days. Then, a Taber wear tester (manufactured by DAITO ELECTRON CO., LTD., conditions: a load of 1 kg, wear wheel H-22) was used to measure a wear amount according to JIS K-7311.
2. Scratch resistance evaluation: Evaluated according to JIS K 5600-5-4 pencil scratch hardness measurement method
3. Izod impact strength: Evaluated about ASTM D256, ¼ inch thick specimens at room temperature.

TABLE 8

| | Example | Example | Example | Example | Example | Example | Comparative |
|---|---|---|---|---|---|---|---|
| Item | 33 | 34 | 35 | 36 | 37 | 38 | Example 10 |
| Wear | 18 | 20 | 19 | 22 | 20 | 16 | 44 |
| resistance | | | | | | | |
| wear | | | | | | | |
| amount | | | | | | | |
| (mg) | | | | | | | |
| Scratch | 3H | 3H | 3H | 2H | 3H | 3H | 2H |
| resistance | | | | | | | |
| Izod impact | 42 | 40 | 44 | 38 | 42 | 45 | 44 |
| strength | | | | | | | |
| (kg · cm/cm) | | | | | | | |

As shown in Table 8, in Example 33 to 38, wear resistance, scratch resistance and impact strength were evaluated to be superior to the comparative examples, and it was proved to be suitable for use as a bedding cleaner cam.

The polyketone bedding cleaner cam of the present invention has an wear amount of 25 mg or less, which is excellent.

### Example 39

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 48 g/10 min, residual amount of palladium catalyst was 10 ppm, and a molecular weight distribution was 2.0. The polyketone terpolymer prepared above was molded into pellets on an extruder using a biaxial screw having a diameter of 2.5 cm and L/D=32, which was operated at 250 rpm, and then injection molded to produce a specimen for a polyketone office supply.

Apart from the above specimen, a polyketone composition was prepared by incorporating a silicone oil, which is a wear resistant agent, into the polyketone, wherein the content of the silicone oil was 1.0 weight % based on total composition. After produced the polyketone composition, it was produced into pellets in same method as a pellet preparation described above to prepare a specimen for a polyketone office component.

### Comparative Example 11

A polyoxymethylene resin was produced into pellets on an extruder using a biaxial screw having a diameter of 2.5 cm and L/D=32, which was operated at 250 rpm to prepare a specimen for a polyketone office component. And apart from that, a specimen for an polyketone office component by adding same amount of silicone oil as Example 1.

### Properties Evaluation

Wear resistance and impact resistance of each of the specimens for office components prepared in Example 39 and Comparative Example 11 were evaluated in case of a base state and a case where a wear resistance agent was added, respectively, and results are shown in Table 9.
1. Friction-wear resistance (Ring-on-Ring type, large resin): A through-type test piece having an outer diameter of 25.6 mm, an inner diameter of 20 mm and a height of 15 mm is injection-molded, fixed to a test apparatus, and subjected to a test under a driving condition of a pressure load of 6.6 kgf and a linear velocity of 10 cm/s. Wear resistance was evaluated by evaluating a non-wear amount. The smaller the amount of non-wear obtained, the better the friction-wear resistance.
2. Izod impact strength: Performed according to ASTM D256.

TABLE 9

| | | | | | wear | | |
|---|---|---|---|---|---|---|---|
| | | | | | amount | | impact |
| | | | | Coefficient | (mm³/ | | strength |
| | | specific | Cycle | of | kg/ | | (kJ/ |
| | Grade | gravity | time(s) | friction | km) | noise | m2) |
| Example | Base | 1.24 | 17 | 0.34 | 0.60 | NO(60) | 10 |
| 39 | Wear | | | 0.10 | 0.01 | NO(60) | |
| | resistant | | | | | | |
| | agent | | | | | | |
| | added | | | | | | |
| Comparative | Base | 1.42 | 22 | 0.40 | 8.10 | squeak | 6.5 |
| Example | | | | | | noise(80) | |
| 11 | Wear | | | 0.13 | 0.10 | NO(60) | |
| | resistant | | | | | | |
| | agent | | | | | | |
| | added | | | | | | |

As shown in Table 9, it was evaluated that the wear resistance and the impact resistance in polyketone base state were superior to those in POM base state, and the wear resistance and the impact resistance were also excellent in a case where wear resistant agent was added, thereby the polyketone office components produced by the example of the present invention had excellent impact resistance and wear resistance and was very suitable for application to polyketone office components.

### Example 40

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a window drum for automobiles.

### Example 41

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 74° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.6 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a window drum for automobiles.

### Example 42

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 9 times the molar ratio, and two stages of the first stage at a polymerization temperature of 72° C. and the second stage at 78° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 2.0 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a window drum for automobiles.

### Example 43

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were molded into pellets on an extruder using a biaxial screw having a diameter of 40 mm and L/D=32, which was operated at 250 rpm, and then injection molded to produce a specimen for a window drum for automobiles.

### Comparative Example 12

A polyoxymethylene resin was molded into pellets on an extruder using a biaxial screw having a diameter of 40 cm and L/D=32, which was operated at 250 rpm, and then injection molded into a specimen of a window drum for automobiles.

### Properties Evaluation

Properties of the specimens prepared in Examples 40 to 43 and Comparative Example 11 were evaluated in following method, and results are shown in Table 10.
1. Izod impact strength evaluation: Performed according to ASTM D256.
2. Friction coefficient: Coefficient of kinetic friction is a value that can represent a degree of kinetic friction. The larger the coefficient of kinetic friction means the greater the frictional force, and the smaller the value, the smaller the frictional force.
3. Wear property evaluation: Performed according to JIS K7218 (test condition: 3 km wear at 50 rmp and 150 N)

TABLE 10

| | Example | Example | Example | Example | Comparative |
|---|---|---|---|---|---|
| Item | 40 | 41 | 42 | 43 | Example 12 |
| impact strength | 11 | 12 | 11 | 10 | 6 |
| (kJ/m2) | | | | | |
| friction coefficient | 0.34 | 0.33 | 0.35 | 0.14 | 0.15 |
| Wear property | 0.009 | 0.008 | 0.010 | 0.004 | 0.191 |
| (g) | | | | | |

As can be seen in Table 10, the impact strength of the Examples was improved compared to Comparative Example 11. Further, in case of Examples, the coefficient of kinetic friction and wear property were smaller than those of Comparative Example 12, thereby the frictional force was small and the wear resistance was improved. Therefore, a window drum manufactured by the examples of the present invention exhibits better impact resistance and wear resistance than the comparative example used as a conventional window drum material, and thus is more suitable for application as a window drum for automobiles.

### Example 44

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a sun visor retainer for automobiles.

### Example 45

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 74° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.6 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a sun visor retainer for automobiles.

### Example 46

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 9 times the molar ratio, and two stages of the first stage at a polymerization temperature of 72° C. and the second stage at 78° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 2.0 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a sun visor retainer for automobiles.

### Comparative Example 13

Nylon 6 resin was molded into pellets on an extruder using a biaxial screw having a diameter of 40 mm and L/D=32, which was operated at 250 rpm, and then injection molded to produce a specimen for a sun visor retainer for automobiles.

### Properties Evaluation

Coefficient of kinetic friction, wear property and impact strength of the specimens prepared in Example 44 to 46 and Comparative Example 13 respectively were evaluated by following method. Results are shown in Table 11.

Coefficient of kinetic friction is a value of a degree of kinetic friction. The larger the coefficient of kinetic friction, the greater the frictional force. The smaller the value, the smaller the frictional force.

Wear property is a value indicating a degree of wear. The larger the wear property, the smaller the wear resistance because wear occurs more easily. Meanwhile, the smaller the value, the greater the wear resistance. Wear property test was carried out in a pin-on-disk type under conditions of a load of 1 kg, a linear velocity of 7 Hz and a test time of 30 minutes.

In addition, a dimensional change rate was measured according to MS211-47 in vertical and horizontal directions at a temperature of 50° C. and a relative humidity of 90%.

TABLE 11

| | | | | Comparative |
|---|---|---|---|---|
| Item | Example 44 | Example 45 | Example 46 | Example 13 |
| Coefficient of | 0.10 | 0.15 | 0.12 | 0.40 |
| kinetic friction | | | | |
| Wear property | 0.60 | 0.65 | 0.70 | 8.10 |
| (Rmax) | | | | |
| Dimensional | 1.3 | 1.1 | 1.2 | 5.2 |
| change rate | | | | |
| (%) | | | | |

As can be seen in Table 11, the impact strength of the example was improved compared to the comparative example, and the coefficient of kinetic friction and the wear property were small, thereby the frictional force was small and the wear resistance was improved. Therefore, the sun visor retainer for automobiles manufactured by the examples of the present invention exhibits superior wear resistance and dimensional stability as compared with the comparative example used as a conventional sun visor retainer material for automobiles, thereby it is suitable for application as a sun visor retainer for automobiles.

### Example 47

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the polyketone terpolymer prepared above, carbon monoxide was 50 mol %, ethylene was 46 mol %, and propylene was 4 mol %. Also, a melting point of the polyketone terpolymer was 220° C., LVN measured at 25° C. by HFIP (hexa-fluoroisopropano) was 1.4 dl/g, and MWD was 2.0.

70 weight % of the polyketone terpolymer prepared above and 30 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for a door frame inner cover for automobiles.

### Example 48

75 weight % of the polyketone terpolymer prepared in same method as Example 47 and 25 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for a door frame inner cover for automobiles.

### Example 49

80 weight % of the polyketone terpolymer prepared in same method as Example 47 and 20 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for a door frame inner cover for automobiles.

### Example 50

85 weight % of the polyketone terpolymer prepared in same method as Example 47 and 15 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for a door frame inner cover for automobiles.

### Comparative Example 14

A nylon 66 resin and 30 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for a door frame inner cover for automobiles.

### Properties Evaluation

Properties of the specimens prepared in Example 47 to 50 and Comparative Example 14 were evaluated in following method. Results are shown in Table 12.
1. Izod impact strength evaluation: Performed according to ASTM D256.
2. Dimensional change rate evaluation: Evaluation was made according to MS211-47 for vertical and horizontal directions at a temperature of 50° C. and a relative humidity of 90%.

TABLE 12

| | Example | Example | Example | Example | Comparative |
|---|---|---|---|---|---|
| Item | 47 | 48 | 49 | 50 | Example 14 |
| impact | 25 | 23 | 28 | 27 | 18 |
| strength | | | | | |
| (kJ/m2) | | | | | |
| Dimen- | 1.3 | 1.1 | 1.2 | 1.5 | 5.2 |
| sional | | | | | |
| change | | | | | |
| rate (%) | | | | | |

As can be seen in Table 12, the impact strength and dimensional stability of the Examples were improved compared with Comparative Examples. Therefore, the door frame inner cover for automobiles manufactured by the examples of the present invention shows better dimensional stability than a conventional material of door frame inner cover for automobiles, thereby it is suitable for application as a door frame inner cover for automobiles.

### Example 51

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a safety belt jointer for automobiles.

### Example 52

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were inserted to produce a composition and the produced composition was molded into pellets on an extruder using a biaxial screw having a diameter of 40 mm and L/D=32, which was operated at 250 rpm, and then injection molded to produce a specimen for a safety belt jointer for automobiles.

### Example 53

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a glass fiber were inserted to produce a composition and the produced composition was molded into pellets on an extruder using a biaxial screw having a diameter of 40 mm and L/D=32, which was operated at 250 rpm, and then injection molded to produce a specimen for a safety belt jointer for automobiles.

### Example 54

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for a safety belt jointer for automobiles.

### Comparative Example 15

A nylon 66 resin was molded into pellets on an extruder using a biaxial screw having a diameter of 40 mm and L/D=32, which was operated at 250 rpm, and then injection molded to produce a specimen for a safety belt jointer for automobiles.

### Properties Evaluation

Coefficient of kinetic friction, wear property and impact strength of the specimens prepared in Example 51 to 54 and Comparative Example 15 respectively were evaluated by following method. Results are shown in Table 13.
1. Izod impact strength evaluation: Performed according to ASTM D256.
2. Friction coefficient: Coefficient of kinetic friction is a value that can represent a degree of kinetic friction. The larger the coefficient of kinetic friction means the greater the frictional force, and the smaller the value, the smaller the frictional force.
3. Wear property evaluation: Performed according to JIS K7218 (test condition: 3 km wear at 50 rmp and 150 N)

TABLE 13

| | Example | Example | Example | Example | Comparative |
|---|---|---|---|---|---|
| Item | 51 | 52 | 53 | 54 | Example 15 |
| impact | 11 | 10 | 14 | 14 | 5 |
| strength | | | | | |
| (kJ/m2) | | | | | |
| Friction | 0.34 | 0.14 | 0.3 | 0.25 | 0.35 |
| coefficient | | | | | |
| Wear | 0.009 | 0.004 | 0.006 | 0.003 | 0.007 |
| property | | | | | |
| (g) | | | | | |

As can be seen in Table 13, the impact strength of the example was improved compared to the comparative example, and the coefficient of kinetic friction and the wear property were small, thereby the frictional force was small and the wear resistance was improved. Therefore, the safety belt jointer for automobiles manufactured by the examples of the present invention exhibits superior wear resistance and impact strength as compared with the comparative example used as a conventional material for a safety belt jointer for automobiles, thereby it is suitable for application as a safety belt jointer for automobiles.

### Example 55

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for an auto gear slide for automobiles.

### Example 56

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were inserted to produce a composition and the produced composition was molded into pellets on an extruder using a biaxial screw having a diameter of 40 mm and L/D=32, which was operated at 250 rpm, and then injection molded to produce a specimen for an auto gear slide for automobiles.

### Example 57

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a glass fiber were inserted to produce a composition and the produced composition was molded into pellets on an extruder using a biaxial screw having a diameter of 40 mm and L/D=32, which was operated at 250 rpm, and then injection molded to produce a specimen for an auto gear slide for automobiles.

### Example 58

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for an auto gear slide for automobiles.

### Comparative Example 16

A polyester elastomer (PEL) was molded into pellets on an extruder using a biaxial screw having a diameter of 40 cm and L/D=32, which was operated at 250 rpm, and then injection molded to produce a specimen for an auto gear slide for automobiles.

### Properties Evaluation

Properties of the specimens prepared in Example 55 to 58 and Comparative Example 16 were evaluated in following method and results are shown in Table 6.
1. Friction coefficient: Coefficient of kinetic friction is a value that can represent a degree of kinetic friction. The larger the coefficient of kinetic friction means the greater the frictional force, and the smaller the value, the smaller the frictional force.
2. Wear property evaluation: Performed according to JIS K7218 (test condition: 3 km wear at 50 rmp and 150 N)

TABLE 14

| | Example | Example | Example | Example | Comparative |
|---|---|---|---|---|---|
| Item | 55 | 56 | 57 | 58 | Example 16 |
| Coeffi- | 0.34 | 0.14 | 0.3 | 0.25 | 0.4 |
| cient | | | | | |
| of kinetic | | | | | |
| friction | | | | | |
| Wear | 0.009 | 0.004 | 0.006 | 0.003 | 0.081 |
| property | | | | | |
| (g) | | | | | |

As can be seen in Table 14, the coefficient of kinetic friction and the wear property of the Examples were smaller than those of the Comparative Example, thereby the frictional force was small and the wear resistance was improved. Therefore, the auto gear slide for automobiles manufactured by the examples of the present invention shows better wear resistance than the comparative example used for a conventional material of auto gear slide for automobiles.

### Example 59

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a door latch housing for automobiles.

### Example 60

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 74° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.6 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a door latch housing for automobiles.

### Example 61

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 9 times the molar ratio, and two stages of the first stage at a polymerization temperature of 72° C. and the second stage at 78° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 2.0 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a door latch housing for automobiles.

### Example 62

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were molded into pellets on an extruder using a biaxial screw having a diameter of 40 mm and L/D=32, which was operated at 250 rpm, and then injection molded to produce a specimen for a door latch housing for automobiles.

### Comparative Example 17

A polyoxymethylene resin was molded into pellets on an extruder using a biaxial screw having a diameter of 40 cm and L/D=32, which was operated at 250 rpm, and then injection molded to produce a specimen for a door latch housing for automobiles.

### Properties Evaluation

Properties of the specimens prepared in Example 59 to 62 and Comparative Example 17 were evaluated in following method and results are shown in Table 15.
1. Izod impact strength evaluation: Performed according to ASTM D256.
2. Friction coefficient: Coefficient of kinetic friction is a value that can represent a degree of kinetic friction. The larger the coefficient of kinetic friction means the greater the frictional force, and the smaller the value, the smaller the frictional force.
3. Wear property evaluation: Performed according to JIS K7218 (test condition: 3 km wear at 50 rmp and 150 N)

TABLE 15

| | Example | Example | Example | Example | Comparative |
|---|---|---|---|---|---|
| Item | 59 | 60 | 61 | 62 | Example 17 |
| impact | 11 | 12 | 11 | 10 | 6 |
| strength | | | | | |
| (kJ/m2) | | | | | |
| Friction | 0.34 | 0.33 | 0.35 | 0.14 | 0.15 |
| coefficient | | | | | |
| Wear | 0.009 | 0.008 | 0.010 | 0.004 | 0.191 |
| property | | | | | |
| (g) | | | | | |

As can be seen in Table 15, the impact strength of the Examples was improved compared to Comparative Example 16. Also, the coefficient of kinetic friction and the wear property of the Examples were smaller than those of the Comparative Example 17, thereby the frictional force was small and the wear resistance was improved. Therefore, the door latch housing for automobiles manufactured by the examples of the present invention shows better impact resistance and wear resistance than the comparative example used for a conventional material of door latch housing for automobiles, thereby it is suitable for application as a door latch housing for automobiles.

### Example 63

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a slide guide for automobiles.

### Example 64

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 74° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.6 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a slide guide for automobiles.

### Example 65

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 9 times the molar ratio, and two stages of the first stage at a polymerization temperature of 72° C. and the second stage at 78° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 2.0 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a slide guide for automobiles.

### Example 66

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were molded into pellets on an extruder using a biaxial screw having a diameter of 40 mm and L/D=32, which was operated at 250 rpm, and then injection molded to produce a specimen for a slide guide for automobiles.

### Comparative Example 18

A polyoxymethylene resin was molded into pellets on an extruder using a biaxial screw having a diameter of 40 cm and L/D=32, which was operated at 250 rpm, and then injection molded to produce a specimen for a slide guide for automobiles.

### Properties Evaluation

Properties of the specimens prepared in Example 63 to 66 and Comparative Example 18 were evaluated in following method and results are shown in Table 16.
1. Izod impact strength evaluation: Performed according to ASTM D256.
2. Friction coefficient: Coefficient of kinetic friction is a value that can represent a degree of kinetic friction. The larger the coefficient of kinetic friction means the greater the frictional force, and the smaller the value, the smaller the frictional force.
3. Wear property evaluation: Performed according to JIS K7218 (test condition: 3 km wear at 50 rmp and 150 N)

TABLE 16

| | Example | Example | Example | Example | Comparative |
|---|---|---|---|---|---|
| Item | 63 | 64 | 65 | 66 | Example 18 |
| impact | 11 | 12 | 11 | 10 | 6 |
| strength | | | | | |
| (kJ/m2) | | | | | |
| Friction | 0.34 | 0.33 | 0.35 | 0.14 | 0.15 |
| coefficient | | | | | |
| Wear | 0.009 | 0.008 | 0.010 | 0.004 | 0.191 |
| property | | | | | |
| (g) | | | | | |

As can be seen in Table 16, the impact strength of the Examples was improved compared to Comparative Example 18. Also, the coefficient of kinetic friction and the wear property of the Examples were smaller than those of the Comparative Example 18, thereby the frictional force was small and the wear resistance was improved. Therefore, the slide guide for automobiles manufactured by the examples of the present invention shows better impact resistance and wear resistance than the comparative example used for a conventional material of slide guide for automobiles, thereby it is suitable for application as a slide guide for automobiles.

### Example 67

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a switch shaft in heating, ventilation and air conditioning (HAVC) systems for automobiles.

### Example 68

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were inserted to produce a composition and the produced composition was molded into pellets on an extruder using a biaxial screw having a diameter of 40 mm and L/D=32, which was operated at 250 rpm, and then injection molded to produce a specimen for a switch shaft in heating, ventilation and air conditioning (HAVC) systems for automobiles.

### Example 69

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber were inserted to produce a composition and the produced composition was molded into pellets on an extruder using a biaxial screw having a diameter of 40 mm and L/D=32, which was operated at 250 rpm, and then injection molded to produce a specimen for a switch shaft in heating, ventilation and air conditioning (HAVC) systems for automobiles.

### Example 70

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for a switch shaft in heating, ventilation and air conditioning (HAVC) systems for automobiles.

### Comparative Example 19

A polyoxymethylene resin was molded into pellets on an extruder using a biaxial screw having a diameter of 40 cm and L/D=32, which was operated at 250 rpm, and then injection molded to produce a specimen for a switch shaft in heating, ventilation and air conditioning (HAVC) systems for automobiles.

### Properties Evaluation

Properties of the specimens prepared in Example 67 to 70 and Comparative Example 19 were evaluated in following method and results are shown in Table 17.
1. Izod impact strength evaluation: Performed according to ASTM D256.
2. Friction coefficient: Coefficient of kinetic friction is a value that can represent a degree of kinetic friction. The larger the coefficient of kinetic friction means the greater the frictional force, and the smaller the value, the smaller the frictional force.
3. Wear property evaluation: Performed according to JIS K7218 (test condition: 3 km wear at 50 rmp and 150N)

TABLE 17

| | Example | Example | Example | Example | Comparative |
|---|---|---|---|---|---|
| Item | 67 | 68 | 69 | 70 | Example 19 |
| impact | 11 | 10 | 14 | 14 | 6 |
| strength | | | | | |
| (kJ/m2) | | | | | |
| Friction | 0.34 | 0.14 | 0.3 | 0.25 | 0.15 |
| coefficient | | | | | |
| Wear | 0.009 | 0.004 | 0.006 | 0.003 | 0.191 |
| property | | | | | |
| (g) | | | | | |

As can be seen in Table 17, the impact strength of the Examples was improved compared to Comparative Example 19. Also, the coefficient of kinetic friction and the wear property of the Examples were smaller than those of the Comparative Example 19, thereby the frictional force was small and the wear resistance was improved. Therefore, the switch shaft in heating, ventilation and air conditioning (HAVC) systems for automobiles manufactured by the examples of the present invention shows better impact resistance and wear resistance than the comparative example used for a conventional material of switch shaft in heating, ventilation and air conditioning (HAVC) systems for automobiles, thereby it is suitable for application as a switch shaft in heating, ventilation and air conditioning (HAVC) systems for automobiles.

### Example 71

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for an actuator gear for automobiles.

### Example 72

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were inserted to produce a composition and the produced composition was molded into pellets on an extruder using a biaxial screw having a diameter of 40 mm and L/D=32, which was operated at 250 rpm, and then injection molded to produce a specimen for an actuator gear for automobiles.

### Example 73

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a glass fiber were inserted to produce a composition and the produced composition was molded into pellets on an extruder using a biaxial screw having a diameter of 40 mm and L/D=32, which was operated at 250 rpm, and then injection molded to produce a specimen for an actuator gear for automobiles.

### Example 74

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for an actuator gear for automobiles.

### Comparative Example 20

A polyoxymethylene resin was molded into pellets on an extruder using a biaxial screw having a diameter of 40 cm and L/D=32, which was operated at 250 rpm, and then injection molded to produce a specimen for an actuator gear for automobiles.

### Properties Evaluation

Properties of the specimens prepared in Example 71 to 74 and Comparative Example 20 were evaluated in following method and results are shown in Table 18.
1. Izod impact strength evaluation: Performed according to ASTM D256.
2. Friction coefficient: Coefficient of kinetic friction is a value that can represent a degree of kinetic friction. The larger the coefficient of kinetic friction means the greater the frictional force, and the smaller the value, the smaller the frictional force.
3. Wear property evaluation: Performed according to JIS K7218 (test condition: 3 km wear at 50 rmp and 150 N)

TABLE 18

| | Example | Example | Example | Example | Comparative |
|---|---|---|---|---|---|
| Item | 71 | 72 | 73 | 74 | Example 20 |
| impact | 11 | 10 | 14 | 14 | 6 |
| strength | | | | | |
| (kJ/m2) | | | | | |
| Friction | 0.34 | 0.14 | 0.3 | 0.25 | 0.15 |
| coefficient | | | | | |
| Wear | 0.009 | 0.004 | 0.006 | 0.003 | 0.191 |
| property | | | | | |
| (g) | | | | | |

As can be seen in Table 18, the impact strength of the Examples was improved compared to Comparative Example 20. Also, the coefficient of kinetic friction and the wear property of the Examples were smaller than those of the Comparative Example 20, thereby the frictional force was small and the wear resistance was improved. Therefore, the actuator gear for automobiles manufactured by the examples of the present invention shows better impact resistance and wear resistance than the comparative example used for a conventional material of actuator gear for automobiles, thereby it is suitable for application as an actuator gear for automobiles.

### Example 75

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 22° 0° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a trim mounting clip for automobiles.

### Example 76

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were inserted to produce a composition and the produced composition was molded into pellets on an extruder using a biaxial screw having a diameter of 40 mm and L/D=32, which was operated at 250 rpm, and then injection molded to produce a specimen for a trim mounting clip for automobiles.

### Example 77

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a glass fiber were inserted to produce a composition and the produced composition was molded into pellets on an extruder using a biaxial screw having a diameter of 40 mm and L/D=32, which was operated at 250 rpm, and then injection molded to produce a specimen for a trim mounting clip for automobiles.

### Example 78

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for a trim mounting clip for automobiles.

### Comparative Example 21

A polyoxymethylene resin was molded into pellets on an extruder using a biaxial screw having a diameter of 40 cm and L/D=32, which was operated at 250 rpm, and then injection molded to produce a specimen for a trim mounting clip for automobiles.

### Properties Evaluation

Properties of the specimens prepared in Example 75 to 78 and Comparative Example 21 were evaluated in following method and results are shown in Table 19.
1. Izod impact strength evaluation: Performed according to ASTM D256.
2. Friction coefficient: Coefficient of kinetic friction is a value that can represent a degree of kinetic friction. The larger the coefficient of kinetic friction means the greater the frictional force, and the smaller the value, the smaller the frictional force.
3. Wear property evaluation: Performed according to JIS K7218 (test condition: 3 km wear at 50 rmp and 150 N)

TABLE 19

| | Example | Example | Example | Example | Comparative |
|---|---|---|---|---|---|
| Item | 75 | 76 | 77 | 78 | Example 21 |
| impact | 11 | 10 | 14 | 14 | 6 |
| strength | | | | | |
| (kJ/m2) | | | | | |
| Friction | 0.34 | 0.14 | 0.3 | 0.25 | 0.15 |
| coefficient | | | | | |
| Wear | 0.009 | 0.004 | 0.006 | 0.003 | 0.191 |
| property | | | | | |
| (g) | | | | | |

As can be seen in Table 19, the impact strength of the Examples was improved compared to Comparative Example 21. Also, the coefficient of kinetic friction and the wear property of the Examples were smaller than those of the Comparative Example 21, thereby the frictional force was small and the wear resistance was improved. Therefore, the trim mounting clip for automobiles manufactured by the examples of the present invention shows better impact resistance and wear resistance than the comparative example used for a conventional material of trim mounting clip for automobiles, thereby it is suitable for application as a trim mounting clip for automobiles.

### Example 79

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a cup holder for automobiles.

### Example 80

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were inserted to produce a composition and the produced composition was molded into pellets on an extruder using a biaxial screw having a diameter of 40 mm and L/D=32, which was operated at 250 rpm, and then injection molded to produce a specimen for a cup holder for automobiles.

### Example 81

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a glass fiber were inserted to produce a composition and the produced composition was molded into pellets on an extruder using a biaxial screw having a diameter of 40 mm and L/D=32, which was operated at 250 rpm, and then injection molded to produce a specimen for a cup holder for automobiles.

### Example 82

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for a cup holder for automobiles.

### Comparative Example 22

A polyoxymethylene resin was molded into pellets on an extruder using a biaxial screw having a diameter of 40 cm and L/D=32, which was operated at 250 rpm, and then injection molded to produce a specimen for a cup holder for automobiles.

### Properties Evaluation

Properties of the specimens prepared in Example 79 to 82 and Comparative Example 22 were evaluated in following method and results are shown in Table 20.
1. Izod impact strength evaluation: Performed according to ASTM D256.
2. Friction coefficient: Coefficient of kinetic friction is a value that can represent a degree of kinetic friction. The larger the coefficient of kinetic friction means the greater the frictional force, and the smaller the value, the smaller the frictional force.
3. Wear property evaluation: Performed according to JIS K7218 (test condition: 3 km wear at 50 rmp and 150N)

TABLE 20

| | Example | Example | Example | Example | Comparative |
|---|---|---|---|---|---|
| Item | 79 | 80 | 81 | 82 | Example 22 |
| impact | 11 | 10 | 14 | 14 | 6 |
| strength | | | | | |
| (kJ/m2) | | | | | |
| Friction | 0.34 | 0.14 | 0.3 | 0.25 | 0.15 |
| coefficient | | | | | |
| Wear | 0.009 | 0.004 | 0.006 | 0.003 | 0.191 |
| property | | | | | |
| (g) | | | | | |

As can be seen in Table 20, the impact strength of the Examples was improved compared to Comparative Example 22. Also, the coefficient of kinetic friction and the wear property of the Examples were smaller than those of the Comparative Example 22, thereby the frictional force was small and the wear resistance was improved. Therefore, the cup holder for automobiles manufactured by the examples of the present invention shows better impact resistance and wear resistance than the comparative example used for a conventional material of cup holder for automobiles, thereby it is suitable for application as a cup holder for automobiles.

### Example 83

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the polyketone terpolymer prepared above, carbon monoxide was 50 mol %, ethylene was 46 mol %, and propylene was 4 mol %. Also, a melting point of the polyketone terpolymer was 220° C., LVN measured at 25° C. by HFIP (hexa-fluoroisopropano) was 1.4 dl/g, and MWD was 2.0.

90 weight % of the polyketone terpolymer prepared above and 10 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for a roof rack for automobiles.

### Example 84

The same as Example 83 except that the polyketone content was 80 weight % and the glass fiber content was 20 weight %.

### Example 85

The same as Example 83 except that the polyketone content was 70 weight % and the glass fiber content was 30 weight %.

### Example 86

The same as Example 83 except that the polyketone content was 60 weight % and the glass fiber content was 40 weight %.

### Comparative Example 23

70 weight % of nylon 66 resin, 15 weight % of glass fiber and 15 weight % of mineral filler were inserted to produce a composition and the produced composition was molded into pellets on an extruder using a biaxial screw having a diameter of 40 cm and L/D=32, which was operated at 250 rpm, and then injection molded to produce a specimen for a roof rack for automobiles.

### Properties Evaluation

Properties of the specimens prepared in Example 83 to 86 and Comparative Example 23 were evaluated in following method and results are shown in Table 21.
1. Izod impact strength evaluation: Performed according to ASTM D256.
2. Scratch resistance evaluation: Evaluated according to JIS K 5600-5-4 pencil scratch hardness measurement method.

TABLE 21

| | Example | Example | Example | Example | Comparative |
|---|---|---|---|---|---|
| Item | 83 | 84 | 85 | 86 | Example 23 |
| impact | 10 | 10 | 13 | 15 | 7 |
| strength | | | | | |
| (kJ/m2) | | | | | |
| Scratch | 3H | 3H | 3H | 3H | 2H |
| resistance | | | | | |

As can be seen in Table 21, the scratch resistance and the impact strength of the examples were evaluated to be superior to those of the comparative example, thereby they were found to have properties suitable for use in roof racks for automobiles.

### Example 87

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, and MWD was 2.0. 75 weight % of the polyketone terpolymer prepared above, 10 weight % of glass fiber and 15 weight % of mineral filler which was mixed with 60 to 75 weight % of silica and 25 to 40 weight % of magnesium oxide were mixed and molded into pellets on an extruder using a biaxial screw having a diameter of 40 mm and L/D=32, which was operated at 250 rpm, and then injection molded to produce a specimen for an outside door handle for automobiles and its properties were evaluated.

### Example 88

The same as Example 87 except that the glass fiber content was 5 weight % and the mineral filler content was 10 weight %.

### Example 89

The same as Example 87 except that the glass fiber content was 20 weight % and the mineral filler content was 20 weight %.

### Comparative Example 24

70 weight % of nylon 66 resin, 15 weight % of glass fiber and 15 weight % of mineral filler were inserted to produce a composition and the produced composition was molded into pellets on an extruder using a biaxial screw having a diameter of 40 cm and L/D=32, which was operated at 250 rpm, and then injection molded to produce a specimen for an outside door handle for automobiles.

### Properties Evaluation

Properties of the specimens prepared in Example 87 to 89 and Comparative Example 24 were evaluated in following method and results are shown in Table 22.
1. Izod impact strength evaluation: Performed according to ASTM D256.
2. Scratch resistance evaluation: Evaluated according to JIS K 5600-5-4 pencil scratch hardness measurement method.
3. Dimensional change rate evaluation: Evaluation was made according to MS211-47 for vertical and horizontal directions at a temperature of 50° C. and a relative humidity of 90%.

TABLE 22

| | Example | Example | Example | Comparative |
|---|---|---|---|---|
| Item | 87 | 88 | 89 | Example 24 |
| impact | 12 | 13 | 14 | 7 |
| strength | | | | |
| (kJ/m2) | | | | |
| Scratch | 3H | 3H | 3H | 2H |
| resistance | | | | |
| Dimen- | 1.1 | 1.3 | 1.5 | 5.2 |
| sional | | | | |
| change | | | | |
| rate (%) | | | | |

As can be seen in Table 22, the scratch resistance and the dimensional stability of the examples were evaluated to be superior to those of the comparative example, thereby they were found to have properties suitable for use in outside door handles for automobiles.

### Example 90

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the polyketone terpolymer prepared above, carbon monoxide was 50 mol %, ethylene was 46 mol %, and propylene was 4 mol %. Also, a melting point of the polyketone terpolymer was 220° C., LVN measured at 25° C. by HFIP (hexa-fluoroisopropano) was 1.4 dl/g, and MWD was 2.0.

70 weight % of the polyketone terpolymer prepared above and 30 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for an air intake garnish for automobiles.

### Example 91

75 weight % of the polyketone terpolymer prepared in same method as Example 90 and 25 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for an air intake garnish for automobiles.

### Example 92

80 weight % of the polyketone terpolymer prepared in same method as Example 90 and 20 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for an air intake garnish for automobiles.

### Example 93

85 weight % of the polyketone terpolymer prepared in same method as Example 90 and 15 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for an air intake garnish for automobiles.

### Comparative Example 25

A Nylon 66 resin and 30 weight % of glass fiber were inserted to produce a composition and the produced composition was molded into pellets on an extruder using a biaxial screw having a diameter of 40 cm and L/D=32, which was operated at 250 rpm, and then injection molded to produce a specimen for an air intake garnish for automobiles.

### Properties Evaluation

Properties of the specimens prepared in Example 90 to 93 and Comparative Example 25 were evaluated in following method and results are shown in Table 23.
1. Izod impact strength evaluation: Performed according to ASTM D256.
2. Wear property: Wear property is a value indicating a degree of wear. The larger the wear property, the smaller the wear resistance because wear occurs more easily. Meanwhile, the smaller the value, the greater the wear resistance because wear doesn't occur easily. Wear property test was carried out in a pin-on-disk type under conditions of a load of 1 kg, a linear velocity of 7 Hz and a test time of 30 minutes.
3. Dimensional change rate evaluation: Evaluation was made according to MS211-47 for vertical and horizontal directions at a temperature of 50° C. and a relative humidity of 90%.

TABLE 23

| | Example | Example | Example | Example | Comparative |
|---|---|---|---|---|---|
| Item | 90 | 91 | 92 | 93 | Example 25 |
| impact | 25 | 23 | 21 | 22 | 18 |
| strength | | | | | |
| (kJ/m2) | | | | | |
| Wear | 0.60 | 0.70 | 0.75 | 0.82 | 8.10 |
| property | | | | | |
| (Rmax) | | | | | |
| Dimen- | 1.3 | 1.4 | 1.5 | 1.5 | 5.2 |
| sional | | | | | |
| change | | | | | |
| rate (%) | | | | | |

As can be seen in Table 23, the impact strength and the dimensional stability of the Examples was improved compared to Comparative Example. Also, the coefficient of kinetic friction and the wear property of the Examples were small, thereby the frictional force was small and the wear resistance was improved. Therefore, the air intake garnish for automobiles manufactured by the examples of the present invention shows better wear resistance and dimensional stability than the comparative example used for a conventional material of air intake garnish for automobiles, thereby it is suitable for application as an air intake garnish for automobiles.

### Example 94

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a medical transportation tray.

### Example 95

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were inserted to produce a composition and the produced composition was molded into pellets on an extruder using a biaxial screw having a diameter of 40 mm and L/D=32, which was operated at 250 rpm, and then injection molded to produce a specimen for a medical transportation tray.

### Example 96

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a glass fiber were inserted to produce a composition and the produced composition was molded into pellets on an extruder using a biaxial screw having a diameter of 40 mm and L/D=32, which was operated at 250 rpm, and then injection molded to produce a specimen for a medical transportation tray.

### Example 96

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for a medical transportation tray.

### Comparative Example 26

A specimen for a medical transportation tray was prepared in same method as Example 94 by using polycarbonate which was conventionally used as a material for a medical transportation tray cover.

### Properties Evaluation

The prepared pellets of the above Examples were injection-molded to prepare specimens for medical transportation tray. The properties of the specimens were evaluated by following method in comparison with the specimen of the comparative example, and results are shown in Table 24.
1. Friction coefficient: Coefficient of kinetic friction is a value that can represent a degree of kinetic friction. The larger the coefficient of kinetic friction means the greater the frictional force, and the smaller the value, the smaller the frictional force.
2. Wear property evaluation: Performed according to JIS K7218 (test condition: 3 km wear at 50 rmp and 150 N)

TABLE 24

| | Example | Example | Example | Example | Comparative |
|---|---|---|---|---|---|
| Item | 94 | 95 | 96 | 97 | Example 256 |
| Friction | 0.34 | 0.14 | 0.3 | 0.25 | 0.15 |
| coefficient | | | | | |
| Wear | 0.009 | 0.004 | 0.006 | 0.003 | 0.191 |
| property | | | | | |
| (g) | | | | | |

As can be seen in Table 24, the coefficient of kinetic friction and the wear property of the Examples were smaller than those of the Comparative example 26, thereby the frictional force was small and the wear resistance was improved. Therefore, the medical transportation tray manufactured by the examples of the present invention shows better wear resistance than the comparative example used for a conventional material of medical transportation tray, thereby it is suitable for application as a medical transportation tray.

### Example 98

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.2 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a medical pipette.

### Example 99

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a silicon-based wear resistant agent were inserted to produce a composition and the produced composition was molded into pellets on an extruder using a biaxial screw having a diameter of 40 mm and L/D=32, which was operated at 250 rpm, and then injection molded to produce a specimen for a medical pipette.

### Example 100

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a glass fiber were inserted to produce a composition and the produced composition was molded into pellets on an extruder using a biaxial screw having a diameter of 40 mm and L/D=32, which was operated at 250 rpm, and then injection molded to produce a specimen for a medical pipette.

### Example 101

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above, a glass fiber and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for a medical pipette.

### Comparative Example 27

A specimen for a medical pipette was prepared in same method as Example 98 by using polycarbonate which was conventionally used as a material for a medical pipette.

### Properties Evaluation

The prepared pellets of the above Examples were injection-molded to prepare specimens for medical pipette. The properties of the specimens were evaluated by following method in comparison with the specimen of the comparative example, and results are shown in Table 25.
1. Friction coefficient: Coefficient of kinetic friction is a value that can represent a degree of kinetic friction. The larger the coefficient of kinetic friction means the greater the frictional force, and the smaller the value, the smaller the frictional force.
2. Wear property evaluation: Performed according to JIS K7218 (test condition: 3 km wear at 50 rmp and 150 N)
3. Flexural strength evaluation: Performed according to ASTM D790.

TABLE 25

| | Example | Example | Example | Example | Comparative |
|---|---|---|---|---|---|
| Item | 98 | 99 | 100 | 101 | Example 27 |
| Friction | 0.34 | 0.14 | 0.3 | 0.25 | 0.15 |
| coefficient | | | | | |
| Wear | 0.009 | 0.004 | 0.006 | 0.003 | 0.191 |
| property | | | | | |
| (g) | | | | | |
| Flexural | 60 | 60 | 200 | 185 | 160 |
| strength | | | | | |
| (MPa) | | | | | |

As can be seen in Table 25, the coefficient of kinetic friction and the wear property of the Examples were smaller than those of the Comparative example 27, thereby the frictional force was small and the wear resistance and the flexural strength were improved. Therefore, the medical pipette manufactured by the examples of the present invention shows better wear resistance and flexural strength than the comparative example used for a conventional material of medical pipette, thereby it is suitable for application as a medical pipette.

### Example 102

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a refrigerator door closure.

### Example 103

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for a refrigerator door closure.

### Example 104

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a thermoplastic polyurethane resin were inserted to produce a composition and the produced composition was molded into pellets on an extruder using a biaxial screw having a diameter of 40 mm and L/D=32, which was operated at 250 rpm, and then injection molded to produce a specimen for a refrigerator door closure.

### Comparative Example 28

A specimen for a refrigerator door closure was prepared in same method as Example 102 by using polyoxymethylene resin which was conventionally used as a material for a refrigerator door closure.

### Properties Evaluation

The prepared pellets of the above Examples were injection-molded to prepare specimens for refrigerator door closure. The properties of the specimens were evaluated by following method in comparison with the specimen of the comparative example, and results are shown in Table 26.
1. Friction coefficient: Coefficient of kinetic friction is a value that can represent a degree of kinetic friction. The larger the coefficient of kinetic friction means the greater the frictional force, and the smaller the value, the smaller the frictional force.
2. Wear property evaluation: Performed according to JIS K7218 (test condition: 3 km wear at 50 rmp and 150 N)
3. Noise evaluation: After noise was measured, it was indicated by 0 when it was 40 dB or more, and when it was less than 40 dB, it was indicated by x.

TABLE 26

| | Example | Example | Example | Comparative |
|---|---|---|---|---|
| Item | 102 | 103 | 104 | Example 28 |
| Friction | 0.34 | 0.13 | 0.14 | 0.18 |
| coefficient | | | | |
| Wear | 0.02 | 0.001 | 0.006 | 0.007 |
| property | | | | |
| (g) | | | | |
| Noise | ∘ | x | x | ∘ |
| generation | | | | |

As can be seen in Table 26, the coefficient of kinetic friction and the wear property of the Examples were smaller than those of the Comparative example 28, thereby the frictional force was small and the wear resistance was improved. Therefore, the refrigerator door closure manufactured by the examples of the present invention shows better wear resistance and has less noise than the comparative example used for a conventional material of refrigerator door closure, thereby it is suitable for application as a refrigerator door closure.

### Example 105

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above was molded into pellets on an extruder using a biaxial screw having a diameter of 40 mm and L/D=32, which was operated at 250 rpm, and then injection molded to produce a specimen for a cellular phone polishing fixture.

### Example 106

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 78° C. and the second stage at 84° C. are carried out. In the prepared polyketone terpolymer, a molar ratio of ethylene to propene was 85:15. Also, a melting point of the polyketone terpolymer was 220° C., LVN measured at 25° C. by HFIP (hexa-fluoroisopropano) was 1.4 dl/g, and MWD was 2.0. The polyketone terpolymer prepared above and a polytetrafluoroethylene resin were inserted to produce a composition and the produced composition was molded into pellets on an extruder using a biaxial screw having a diameter of 40 mm and L/D=32, which was operated at 250 rpm, and then injection molded to produce a specimen for a cellular phone polishing fixture.

### Comparative Example 29

A specimen for a cellular phone polishing fixture was prepared in same method as Example 102 by using unsaturated polyester resin which was conventionally used as a material for a cellular phone polishing fixture.

### Properties Evaluation

The prepared pellets of the above Examples were injection-molded to prepare specimens for cellular phone polishing fixture. The properties of the specimens were evaluated by following method in comparison with the specimen of the comparative example, and results are shown in Table 27.
1. Tensile strength evaluation: Performed according to ASTM D638.
2. Wear life evaluation: After a product was mounted on the manufactured specimen for cellular phone polishing fixture, time taken for the polishing fixture to wear by performing polishing was measured.

TABLE 27

| | Example | Example | Comparative |
|---|---|---|---|
| Item | 105 | 106 | Example 29 |
| Tensile strength (MPa) | 60 | 50 | 21 |
| Wear life (day) | 20 | 40 | 30 |

As can be seen in Table 27, the tensile strength of the Examples was improved compared with the comparative example, and the wear life of the Example 106 were longer than that of the Comparative example, thereby the wear resistance was improved. Therefore, the cellular phone polishing fixture manufactured by the examples of the present invention shows better wear resistance and tensile strength than the comparative example used for a conventional material of cellular phone polishing fixture, thereby it is suitable for application as a cellular phone polishing fixture.

### Example 107

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 11 times the molar ratio, and two stages of the first stage at a polymerization temperature of 80° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.2 dl/g, MI (Melt Index) was 60 g/10 min and MWD was 2.0.

100 parts by weight of the polyketone terpolymer prepared above and 1 part by weight of silicone resin were mixed and extruded through melt-kneading on an extruder using a biaxial screw having L/D32 and D 40 at 240° C., which was operated at 250 rpm.

### Example 108

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min and MWD was 2.0. 100 parts by weight of the polyketone terpolymer prepared above and 1 part by weight of silicone resin were mixed and extruded through melt-kneading on an extruder using a biaxial screw having L/D32 and D 40 at 240° C., which was operated at 250 rpm.

### Example 109

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 9 times the molar ratio, and two stages of the first stage at a polymerization temperature of 74° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.6 dl/g, MI (Melt Index) was 60 g/10 min and MWD was 2.0.

100 parts by weight of the polyketone terpolymer prepared above and 1 part by weight of silicone resin were mixed and extruded through melt-kneading on an extruder using a biaxial screw having L/D32 and D 40 at 240° C., which was operated at 250 rpm.

### Example 110

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min and MWD was 1.8.

100 parts by weight of the polyketone terpolymer prepared above and 1 part by weight of silicone resin were mixed and extruded through melt-kneading on an extruder using a biaxial screw having L/D32 and D 40 at 240° C., which was operated at 250 rpm.

### Example 111

Linear alternating polyketone terpolymers comprising carbon monoxide and ethylene and propene are prepared under presence of catalyst composition formed from palladium acetate, trifluoroacetic acid and ((2,2-dimethyl-1,3-dioxane-5,5-diyl)bis(methylene)bis(2-methoxyphenyl) phosphine). In the above, content of trifluoroacetic acid with respect to palladium is 10 times the molar ratio, and two stages of the first stage at a polymerization temperature of 78° C. and the second stage at 84° C. are carried out. In the prepared polyketone terpolymer, a molar ratio of ethylene to propene was 46:4. Also, a melting point of the polyketone terpolymer was 220° C., LVN measured at 25° C. by HFIP (hexa-fluoroisopropano) was 1.4 dl/g, MI (Melt Index) was 60 g/10 min and MWD was 2.2.

100 parts by weight of the polyketone terpolymer prepared above and 1 part by weight of silicone resin were mixed and extruded through melt-kneading on an extruder using a biaxial screw having L/D32 and D 40 at 240° C., which was operated at 250 rpm.

### Comparative Example 30

The same as Example 107 except that POM was used as a material of DuPont in a base state.

### Properties Evaluation

The prepared pellets of the above Examples were injection-molded to prepare specimens for ATM gear. The properties of the specimens were evaluated by following method in comparison with the specimen of the comparative example, and results are shown in Table 28.
1. Product strain rate evaluation: It was evaluated according to MS211-47 for vertical and horizontal directions at a temperature of 50° C. and a relative humidity of 90%.
2. Product weight change rate evaluation: It was evaluated according to MS211-47 at a temperature of 50° C. and a relative humidity of 90%.
3. Water resistance property maintenance rate: After 24 hours treatment at 50° C. and 90% relative humidity, impact strength was measured and compared.
4. Wear amount evaluation: It was evaluated using a cylindrical specimen having an inner diameter of 20 mm, an outer diameter of 25 mm and a height of 15 mm and a counter material. Wear amount was measured at a speed of 50 rpm, a load of 150 N, and a wear distance of 3 km under JIS K7218 standard.

TABLE 28

| | Example | Example | Example | Example | Example | Comparative |
|---|---|---|---|---|---|---|
| Item | 107 | 108 | 109 | 110 | 111 | Example 30 |
| Product strain | 0.05 | 0.05 | 0.04 | 0.05 | 0.05 | 0.15 |
| rate- vertical | | | | | | |
| (50° C., RH 90%) | | | | | | |
| Product strain | 0.02 | 0.02 | 0.02 | 0.02 | 0.02 | 0.08 |
| rate-horizontal | | | | | | |
| (50° C., RH 90%) | | | | | | |
| Product weight | 0.95 | 0.85 | 0.88 | 0.92 | 0.94 | 3.42 |
| change rate | | | | | | |
| (50° C., RH 90%) | | | | | | |
| property | 90 | 88 | 92 | 86 | 88 | 48 |
| maintenance | | | | | | |
| rate | | | | | | |
| (50° C., RH 90%) | | | | | | |
| Wear amount | 0.005 | 0.003 | 0.004 | 0.003 | 0.004 | 0.083 |
| (g) | | | | | | |

As shown in Table 28, the product strain rate in vertical and horizontal directions was lower than that of the comparative example, and the product weight change rate was also lower than that of the comparative example, and it was excellent in water resistance property maintenance rate and wear resistance.

Also, the present invention had a wear amount of 0.020 g or less, which is superior, at a speed of 50 rpm, a load of 150 N, a wear distance of 3 km under JIS K7218 standard.

Accordingly, it is proved that the polyketone resin composition produced by the examples of the present invention can be utilized as an ATM gear and etc. which requires excellent wear resistance.

1-135. (canceled)

136. A polyketone copolymer with excellent wear resistance, comprising repeating units represented by following general formula (1) and (2),
wherein y/x is 0.03 to 0.3 and intrinsic viscosity of the polyketone copolymer is 1.0 to 2.0 dl/g, and a molecular weight distribution is 1.5 to 2.5.
—(CH₂CH₂—CO)x- (1)
—(CH₂CH(CH₃)—CO)y- (2)
(x and y are mole % of each of the general formula (1) and (2) in the copolymer)

137. The polyketone copolymer with excellent wear resistance of claim 136,
wherein ligand of catalyst composition used in polymerization of the polyketone copolymer is ((2,2-dimethyl-1,3-dioxane,5,5-diyl)bis(methylene))bis(bis(2-methoxyphenyl)phosphine).

138. The polyketone copolymer with excellent wear resistance of claim 136,
wherein a residual amount of palladium catalyst of the polyketone copolymer is 5 to 50 ppm.

139. The polyketone copolymer with excellent wear resistance of claim 138,
wherein the polyketone copolymer further comprises one or two more kinds of additive substance selected from a group comprising a silicon-based wear resistant agent, a silicone resin, a glass fiber, a polytetrafluoroethylene and a thermoplastic polyurethane.

140. The polyketone copolymer with excellent wear resistance of claim 139,
wherein the additive substance is 0.1 to 20 parts by weight based on 100 parts by weight of the polyketone copolymer.

141. A polyketone component selected from a group comprising microwave container, polyketone cam, helmet gear for electric welding, polyketone plastic board, polyketone yarn guide, polyketone microwave part, bedding cleaner cam, polyketone office supply, polyketone medical transportation tray, polyketone medical pipette, polyketone refrigerator door closure and polyketone cellular phone polishing fixture, made of the polyketone copolymer of claim 136.

142. A polyketone component selected from a group comprising window drum for automobiles, sun visor retainer for automobiles, safety belt jointer for automobiles, auto gear slide for automobiles, door latch housing for automobiles, slide guide for automobiles, switch shaft in heating, ventilation and air conditioning (HAVC) systems for automobiles, actuator gear for automobiles, trim mounting clip for automobiles and cup holder for automobiles, made of the polyketone copolymer of claim 136.

143. The polyketone component of claim 141,
wherein wear amount of the polyketone copolymer is 0.015 g or less.

144. A polyketone resin composition with excellent wear resistance manufactured by injection molding a blend comprising a polyketone copolymer comprising carbon monoxide and at least one kind of olefinically unsaturated hydrocarbon and having a molecular weight distribution of 1.5 to 2.5; and an one or two more kinds of additive substance selected from a group comprising silicone resin, polytetrafluoroethylene, calcium carbonate, maleic acid, molybdenum, glass fiber, magnesium stearate and mineral filler.

145. The polyketone resin composition with excellent wear resistance of claim 144,
wherein content of the polyketone is 80 to 99.9 weight % based on total weight of the polyketone resin composition and content of the additive substance is 0.1 to 20 weight %.

146. The polyketone resin composition with excellent wear resistance of claim 145,
wherein ligand of catalyst composition used in polymerization of the polyketone copolymer is ((2,2-dimethyl-1,3-dioxane,5,5-diyl)bis(methylene))bis(bis(2-methoxyphenyl)phosphine).

147. The polyketone resin composition with excellent wear resistance of claim 145,
wherein the mineral filler is one selected from a group comprising talc, kaolin, mica, wollastonite, TiO2-coated mica platelets, silica, alumina, borosilicates and oxides.

148. A polyketone component selected from a group comprising wear part in OA, ATM gear, electric/electronic gear, city gas meter gear, razor printer toner gear, polyketone office part and ATM gear, made of the polyketone resin composition of claim 144.

149. A polyketone component selected from a group comprising door frame inner cover for automobiles, roof rack for automobiles, outside door handle for automobiles and air intake garnish for automobiles, made of the polyketone resin composition of claim 144.

150. The polyketone component of claim 148,
wherein impact strength is 10 kJ/m² or more.

151. The polyketone component of claim 149,
wherein impact strength is 10 kJ/m² or more.
